(19) United States
(12) Patent Application Publication
(10) Pub. No.: US 2024/0067821 A1
(43) Pub. Date: Feb. 29, 2024

(54) Thermoplastic Resin for Compression Molding

(71) Applicant: INV Nylon Polymers Americas, LLC, Wilmington (DE)

(72) Inventors: John Buzinkai, Chattanooga, TN (US); Peng He, Shanghai (CN); Isaac K. Iverson, Wichita, KS (US); Charles Richard Langrick, Cleveland (GB); Chee Sern Lim, Kennesaw, GA (US)

(21) Appl. No.: 18/267,796

(22) PCT Filed: Dec. 16, 2021
(86) PCT No.: PCT/IB2021/061878

§ 371 Date: Jun. 16, 2023

Related U.S. Application Data
(60) Provisional application No. 63/126,236, filed on Dec. 16, 2020.
(60) Provisional application No. 63/288,905, filed on Dec. 13, 2021.

(51) Int. Cl. C08L 77/06; B29C 43/00; C08J 3/20; C08K 7/14

(52) U.S. Cl. CPC C08L 77/06; B29C 43/003; C08J 3/203; C08K 7/14; B29K 2077/00; C08J 2377/06; C08J 2477/06; C08L 2201/08; C08L 2203/30; C08L 2205/025; C08L 2205/03; C08L 2310/00

(57) ABSTRACT

Compounded thermoplastic resin, molding composition, compounded polyamide composition, articles formed from the same, and methods of making the resins/compositions and articles. A compounded thermoplastic resin includes a polyamide composition and a random copolymer composition.

### CROSS-REFERENCE TO RELATED APPLICATION

This application claims the benefit of priority to U.S. Provisional Patent Application Ser. No. 63/126,236 filed Dec. 16, 2020 and U.S. Provisional Patent Application Ser. No. 63/288,905 filed Dec. 13, 2021, the disclosures of which are incorporated herein in their entireties by reference.

### FIELD

The disclosure herein relates to modified polyamide (nylon) polymer resins for use in articles and molded parts formed by compression molding process.

### BACKGROUND

The homopolymer, polyhexamethylene adipamide (PA66 or N66), can crystallize very rapidly when cooled from a melt state. The PA66 crystallization rate is known to be strongly temperature dependent and reaches a maximum rate at about 220° C. At this temperature, the kinetic half time (t/2) of crystallization is about one minute. For some polymer applications, this can be a disadvantage, such as for surface appearance and dimensional stability of molded parts from glass fiber (GF) reinforced resins. Copolymers based on PA66 may give better results if crystallization rate is slowed sufficiently.

An aliphatic nylon copolyamide including 60-99.5 mole % hexamethylene adipamide units and 0.5-40 mole % 2-methyl-pentamethylene adipamide units is described in U.S. Pat. No. 5,194,578. This disclosure relates to fibers and textile applications of the co-polyamide.

Large form-factor and light-weight molded parts based on PA66 resins are difficult to manufacture, especially, in injection molding or compression molding process. A conventional compression molding technology called Direct Long Fiber Thermoplastic molding (abbreviated as “D-LFT”) or Long Fiber Thermoplastic Direct molding (abbreviated as “LFT-D”) process, is available but there are problems when PA66 based resins are used.

Direct long-fiber thermoplastic (D-LFT, also referred to as DLFT and LFT-D) compounding and molding currently utilize polyolefins. Styrenic thermoplastics are also gaining popularity in D-LFT molding. Large structural automotive parts, mainly, under-the-hood and external body parts, can be produced using this compression molding technique.

Currently, D-LFT technique uses thermoplastic resins, e.g., PP, ABS, and the like. Use of PA66 based materials is not currently known. Recent attempts were made to fabricate large prototype parts from PA66 and PA6, for example, battery tray application in the electric vehicle (EV) sector. However, the parts could not be produced with either PA6 or PA66. Problems arose with part brittleness and dimensional instability/tolerance.

China Patent Application Publication No. 103,978,651 relates to LFT-D molding process for glass fiber reinforced PA.

A need therefore exists for providing compounded thermoplastic polyamide resins for use in large form-factor and light-weight articles and molded parts formed via compression molding process, especially, D-LFT molding technology. There is also a recognised need for providing compounded thermoplastic polyamide resins for making articles and parts using reinforcement, and in injection molding and extrusion processes.

### SUMMARY

The present invention provides a compounded thermoplastic resin. The compounded thermoplastic resin includes a) from ≥20 to ≤99 wt. % of a polyamide composition including a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent). The compounded thermoplastic resin includes b) up to ≤70 wt. % of a random copolymer composition. The compounded thermoplastic resin includes c) up to 50 wt. % of a co-polyamide of hexamethylene isophthalamide and hexamethylene terephthalamide (PA6I/6T). The compounded thermoplastic resin optionally includes d) up to 60 wt. % of a non-polyhexamethylene adipamide (non-PA66) component. The compounded thermoplastic resin is characterized by Melt Flow Index (MFI) of 10 to 80 g/10 min., melt temperature range of 245-265° C., and crystallization temp range of 195-220° C. The MFI is measured according to ISO Method 1133 for 0.325 kg sample weight having between 0.13 wt. % to 0.20 wt. % moisture at 275° C. test temperature. All wt. % values in parts a)-d) are based on the total mass of the compounded thermoplastic resin.

The present invention provides a method of making a compounded thermoplastic resin. The method includes a) feeding a polyamide, a random copolymer, a co-polyamide of hexamethylene isophthalamide and hexamethylene terephthalamide, and a heat stabilizer. The method includes b) maintaining conditions in the compounding zone to blend the contents to form a homogeneous compounded thermoplastic resin melt. The method includes c) recovering the compounded thermoplastic resin melt from step b). The method also includes d) producing extrudate from step c) compounded thermoplastic resin melt. The compounded thermoplastic resin is characterized by Melt Flow Index (MFI) of 10 to 80. The MFI is measured according to ISO Method 1133 for 0.325 kg sample weight having between 0.13 wt. % to 0.20 wt. % moisture at 275° C. test temperature.

The present invention provides a molded article prepared from the compounded thermoplastic resin described herein. The article is substantially free of reinforcing fiber, or the article is a molded article that includes reinforcing fiber.

The present invention provides a molding composition including a first component including PA66 polyamide having RV from ≥20 to ≤50 measured at room temperature and pressure (RV determined from a 8.4 wt % polyamide solution in 90% formic acid and RV is the ratio of the viscosity of the polyamide solution to the viscosity of the solvent). The molding composition includes a second component including glass fibers where the cumulative number-averaged distribution of the glass fiber in the 0.5-5 mm linear length is ≥20% to ≤70% by weight, based upon total weight of glass fibers in the molding composition. The molding composition also includes a third component selected from at least partially aromatic polyamides and at least partially branched aliphatic polyamides, the third component present in the molding composition at concentration sufficient to suppress molding fractures when a Direct Long Fiber Thermoplastic (DLFT) molding preform is pressed into a DLFT mold at temperature of from 240° C. to 300° C., for example 240° C. to 265° C. As used herein, the terms “partially branched polyamide” and “branched polyamide” mean that at least one diamine or at least one diacid forming the polyamide contains a substantially non-reactive side group (branch), such as the methyl group in 2-methylpentamethylenediamine (D). The resulting condensation polyamides can be referred to as “partially disrupted polyamides” and “disrupted polyamides.”

The present invention provides a molding composition including a first component including PA66 polyamide having RV from ≥20 to ≤50 measured at room temperature and pressure (RV determined from a 8.4 wt % polyamide solution in 90% formic acid and RV is the ratio of the viscosity of the polyamide solution to the viscosity of the solvent). The molding composition includes a second component including short glass fibers. The molding composition also includes a third component selected from at least partially aromatic polyamides and at least partially branched aliphatic polyamides, the third component present in the molding composition at concentration sufficient to suppress molding fractures.

The third component of the molding composition can be present in the molding composition at concentration sufficient to suppressing molding fractures when a DLFT molding preform of dimensions 5×5×5 cm³ is pressed into a DLFT mold of dimensions 1 cm×11.18 cm×11.18 cm at molding composition temperature of 250° C. The third component of the molding composition can be present as ≥5 wt. % to ≤70 wt. % of the molding composition.

In various aspects, the third component of the molding composition can include from ≥1 wt. % to ≤30 wt. % of one or more at least partially branched aliphatic polyamides, wherein the wt. % is based on the total weight of the third component. In various aspects, the third component can include from ≥1 wt. % to ≤100 wt. % of one or more at least partially branched aliphatic aromatic polyamides, wherein the wt. % is based on the total weight of the third component.

The third component is present at concentration sufficient such that when then DLFT molding preform is pressed into a DLFT mold to produce an article having a form factor of from 2 to 5,000 m²/m³ volume-specific surface area, the article is formed without structural defects (as defined herein) when the second component is present at concentration from ≥10 wt. % to ≤60 wt. %, based on the total weight of the molded composition. The term “structural defect” means a deviation from the shape of the mold that, upon visual inspection without magnification, is observed to trigger a recommendation to reject the molded part by a majority of human inspectors. Common forms of structural defects in molded parts and articles may include, and are not limited to, surface appearance, surface finish, surface texture, visible cracks and kinks, dimensional stability in terms of warpage, uneven surfaces, edges and thicknesses that are off-design, ballooning, flaking, indentations, and the like. Such structural defects can potentially compromise the structural integrity and mechanical strength of the molded parts or articles. Such defects are undesirable when making large form-factor, light-weight molded parts and articles. In various aspects, the weight ratio of the second component to the third component can be from ≥0.1 to ≤15.

The present invention provides a compounded thermoplastic resin. The compounded thermoplastic resin includes a) from ≥20 to ≤99 wt. % of a polyamide composition including a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent). The compounded thermoplastic resin includes b) from ≥1 wt. % to ≤70 wt. % of a copolymer of polyhexamethylene adipamide (PA66) and poly-2-methylpentamethylene isophthalamide (DI), wherein the mass ratio of copolymer (PA66/DI) is from 80:20 to 97:3. The compounded thermoplastic resin optionally includes c) up to 60 wt. % of a non-polyhexamethylene adipamide (non-PA66) component. The time to peak crystallization of the compounded thermoplastic resin relative to that of polyhexamethylene adipamide (PA66) slows down by a factor of ≥1.1 and ≤25 in the 140° C. to 220° C. temperature range. The time to peak crystallization is determined using isothermal Fast Scanning Calorimetry (FSC) technique. All wt. % values in parts a)-c) are based on the total mass of the compounded thermoplastic resin.

The present invention provides a compounded thermoplastic resin. The compounded thermoplastic resin includes from ≥20 to ≤99 wt. %, based on the total mass of the compounded thermoplastic resin, of a polyamide composition including a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent). The compounded thermoplastic resin includes from ≥1 wt. % to ≤50 wt. %, based on the total mass of the compounded thermoplastic resin, of a co-polyamide of hexamethylene isophthalamide and hexamethylene terephthalamide (PA6I/6T). The compounded thermoplastic resin optionally includes up to 60 wt. %, based on the total mass of the compounded thermoplastic resin, of a non-polyhexamethylene adipamide (non-PA66) component. The time to peak crystallization of the compounded thermoplastic resin relative to that of polyhexamethylene adipamide (PA66) slows down by a factor of ≥1.1 and ≤50 in the 140° C. to 220° C. temperature range. The time to peak crystallization is determined using isothermal Fast Scanning Calorimetry (FSC) technique.

The present invention provides a compounded polyamide composition. The compounded polyamide composition includes PA66 or PA66/D6 or PA66/DI that is ≥20 to ≤99 wt % of the compounded polyamide composition. The compounded polyamide composition also includes a polymer additive that is up to ≤70 wt % of the compounded polyamide composition. The polymer additive includes a polyamide copolymer; a polymer including a repeating unit including a styrene reaction product; a polyamide formable via ring-opening polymerization; a polyamide including a repeating unit including a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6; or a combination thereof.

The present invention provides a compounded polyamide composition. The compounded polyamide composition includes PA66 or PA66/D6 or PA66/DI that is 25 wt % to 85 wt % of the compounded polyamide composition. The compounded polyamide composition also includes a polymer additive that is 5 wt % to 70 wt % of the compounded polyamide composition. The polymer additive including PA66/DI, PA66/D6, PA6I/6T, PA6, or a combination thereof.

The present invention provides a fiber-compounded polyamide composition including the compounded polyamide composition described herein and including a reinforcing fiber.

The present invention provides a fiber-compounded polyamide composition. The fiber-compounded polyamide composition includes a compounded polyamide composition that is 40 wt % to 90 wt % of the fiber-compounded polyamide composition. The compounded polyamide composition includes PA66 that is 25 wt % to 85 wt % of the compounded polyamide composition. The compounded polyamide composition also include a polymer additive that is 5 wt % to 70 wt % of the compounded polyamide composition. The polymer additive includes PA66/DI, PA66/D6, PA6I/6T, PA6, or a combination thereof. The fiber-compounded polyamide composition also includes glass fibers that are 10 wt % to 60% of the fiber-compounded polyamide composition. At least 25% of the glass fibers have a length ≥0.5 mm as determined via number-averaged fiber length.

The present invention provides a method of forming the compounded polyamide composition described herein. The method includes feeding a composition including PA66 and a polymer additive to a compounding zone. The polymer additive includes a polyamide copolymer; a polymer including a repeating unit including a styrene reaction product; a polyamide formable via ring-opening polymerization; a polyamide including a repeating unit including a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6; or a combination thereof. The method includes maintaining conditions in the compounding zone to blend the composition to form a melted compounded polyamide composition. The method also includes producing extrudate from the melted compounded polyamide composition to form the polyamide composition.

The present invention provides a molded article formed from the compounded polyamide composition described herein. The molded article can be prepared from the fiber-compounded polyamide composition described herein, or from a compounded polyamide composition described herein that is substantially free of fibers.

The present invention provides a method of forming a molded article. The method includes placing the compounded polyamide composition described herein into a mold to form the molded article. The method also includes removing the molded article from the mold.

The present invention provides a molded article formed by the method of forming a molded article described herein.

The present invention provides a method of forming a fiber-reinforced molded article. The method includes placing the fiber-compounded polyamide composition described herein into a mold to form the fiber-reinforced molded article. The method also includes removing the fiber-reinforced molded article from the mold.

The present invention provides a fiber-reinforced molded article formed by the method of forming a fiber-reinforced molded article described herein.

The present invention provides a method of improving direct long fiber thermoplastic molding (D-LFT) or long fiber thermoplastic direct molding (LFT-D) of a fiber-compounded polyamide composition. The method includes including a sufficient amount of polymer additive in the fiber-compounded polyamide composition such that a lower melt flow index, melt temperature, crystallization temperature, or combination thereof, is achieved. The fiber-compounded polyamide composition including the polymer additive includes a compounded polyamide composition. The compounded polyamide composition includes PA66 that is ≥20 to ≤99 wt % of the compounded polyamide composition. The compounded polyamide composition includes a polymer additive that is ≥1 to ≤70 wt % of the compounded polyamide composition. The compounded polyamide composition also includes reinforcing fibers that are 10 wt % to 60% of the fiber-compounded polyamide composition. The polyamide additive includes a polyamide copolymer; a polymer including a repeating unit including a styrene reaction product; a polyamide formable via ring-opening polymerization; a polyamide including a repeating unit including a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6; or a combination thereof.

The compositions described herein can be useful for making articles of manufacture. Examples include molded trays for automotive spare tires and automotive batteries. Other examples of useful articles that be made using the compositions described herein include bicycle wheels and chairs, including one-piece molded chairs.

### BRIEF DESCRIPTION OF THE FIGURE

The FIGURE is a graphical representation of the measured number-averaged glass fiber fraction (Y-axis) as a function of the measured glass fiber length in mm (X-axis) according to various aspects of the present disclosure.

### DETAILED DESCRIPTION

As used herein, the term “PA66/DI” refers to a type of co-polyamide formed by combining PA66 salt solution with DI salt solution, where “D” is an abbreviation for 2-methyl-1,5-pentamethylene diamine (also known as MPMD), and “I” is an abbreviation for isophthalic acid.

As used herein, “PA66/D6” refers to a type of co-polyamide formed by combining PA66 salt solution with D6 salt solution, where “D” is an abbreviation for 2-methyl-1,5-pentamethylene diamine (MPMD) and “6” refers to adipic acid, a C6 dicarboxylic acid.

Known amorphous polyamides based on 2-methyl-1,5-pentamethylene diamine (MPMD) are MPMD-T and MPMD-T/MPMD-I; where the aromatic diacids include the diacid moiety of the polymer; terephthalic acid for MPMD-T and a mixture of terephthalic and isophthalic acids for MPMD-T/MPMD-I. Fundamentally, such polyamides are similar to 6I/6T amorphous polyamides, where the 6-carbon diamine is hexamethylene diamine (HMD). Industrially, MPMD-T is known as “DT” copolyamide, while MPMD-T/MPMD-I is known as “DT/DI” copolyamide.

Amorphous polyamides, when blended with semi-crystalline polyamides such as PA6, PA66 and PA6/66, tend to retard the rate of crystallization and the degree of crystallinity. This property of reduced crystallinity allows for their use as blend additives in the production of extruded and molded nylon articles, films, and the like.

Polyamides can be manufactured by polymerization of dicarboxylic acids and diacid derivatives and diamines. In some cases, polyamides may be produced via polymerization of aminocarboxylic acids, aminonitriles, or lactams. The dicarboxylic acid component is suitably at least one dicarboxylic acid of the molecular formula HO₂C—R₁—CO₂H; wherein R₁ represents a divalent aliphatic, cycloaliphatic or aromatic radical or a covalent bond. R₁ suitably includes from 2 to 20 carbon atoms, for example 2 to 12 carbon atoms, for example 2 to 10 carbon atoms. R₁ may be a linear or branched, for example linear, alkylene radical including 2 to 12 carbon atoms, or 2 to 10 carbon atoms, for example 2, 4, 6 or 8 carbon atoms, an unsubstituted phenylene radical, or an unsubstituted cyclohexylene radical. Optionally, R₁ may contain one or more ether groups. For example, R₁ is an alkylene radical, for example a linear alkylene radical, including 2 to 12 carbon atoms, or 2 to 10 carbon atoms, for example 2, 4, 6 or 8 carbon atoms.

Specific examples of suitable dicarboxylic acids include hexane-1,6-dioic acid (adipic acid), octane-1,8-dioic acid (suberic acid), decane-1,10-dioic acid (sebacic acid), dodecane-1,12-dioic acid, 1,2-cyclohexanedicarboxylic acid, 1,3-cyclohexanedicarboxylic acid, 1,4-cyclohexanedicarboxylic acid, 1,2-cyclohexanediacetic acid, 1,3-cyclohexanediacetic acid, benzene-1,2-dicarboxylic acid (phthalic acid), benzene-1,3-dicarboxylic acid (isophthalic acid), benzene-1,4-dicarboxylic acid (terephthalic acid), 4,4′-oxybis(benzoic acid), and 2,6-naphthalene dicarboxylic acid. A suitable dicarboxylic acid is hexane-1,6-dioic acid (adipic acid).

The diamine component is suitably at least one diamine of the formula H₂N—R₂—NH₂; wherein R₂ represents a divalent aliphatic, cycloaliphatic or aromatic radical. R₂ suitably includes from 2 to 20 carbon atoms, for example 4 to 12 carbon atoms, for example 4 to 10 carbon atoms. R₂ may be a linear or branched, for example linear, alkylene radical including 4 to 12 carbon atoms, for example 4 to 10 carbon atoms, for example 4, 6 or 8 carbon atoms, an unsubstituted phenylene radical, or an unsubstituted cyclohexylene radical. Optionally, R₂ may contain one or more ether groups. For example, R₂ is an alkylene radical, for example a linear alkylene radical, including 4 to 12 carbon atoms, or 4 to 10 carbon atoms, for example 2, 4, 6 or 8 carbon atoms.

Specific examples of suitable diamines include tetramethylene diamine, pentamethylene diamine, hexamethylene diamine, octamethylene diamine, decamethylene diamine, dodecamethylene diamine, 2-methylpentamethylene diamine, 3-methylpentamethylene diamine, 2-methylhexamethylene diamine, 3-methylhexamethylene diamine, 2,5-dimethylhexamethylene diamine, 2,2,4-trimethylhexamethylene diamine, 2,4,4-trimethylhexamethylene diamine, 2,7-dimethyloctamethylene diamine, 2,2,7,7-tetramethyloctamethylene diamine, 1,2-cyclohexanediamine, 1,3-cyclohexanediamine, 1,4-cyclohexanediamine, 4,4′-diaminodicyclohexylmethane, benzene-1,2-diamine, benzene-1,3-diamine and benzene-1,4-diamine. A suitable diamine is hexamethylene diamine.

The aromatic diacid is suitably at least one diacid of the formula HO—C(O)—R₃—C(O)—OH, wherein the variable R₃ is substituted or unsubstituted aryl, such as phenyl. In one aspect, the aromatic diacid is terephthalic acid. In another aspect, the aromatic diacid is isophthalic acid.

The dicarboxylic acids/diacids as well as diamines useful in the polyamide manufacture can be obtained from conventional fossil-based materials, bio-based materials, or combination of the two. Non-limiting examples of such bio-based monomers are bio-adipic acid, bio-suberic acid, bio-sebacic acid (from castor oil), bio-pentamethylene diamine (PMD), bio-hexamethylene diamine (HMD), and the like. It is possible to have a blend of fossil-based and bio-based monomer(s) for polyamide resin production.

The polyamide resin can further include a catalyst. In one aspect, the catalyst can be present in the polyamide resin in an amount ranging from 10 ppm to 1,000 ppm by weight. In another aspect, the catalyst can be present in an amount ranging from 10 ppm to 300 ppm by weight. The catalyst can include, without limitation, phosphorus and oxyphosphorus compounds, such as, phosphoric acid, phosphorous acid, hypophosphorous acid, hypophosphoric acid, arylphosphonic acids, arylphosphinic acids, salts thereof, and mixtures thereof. In one aspect, the catalyst can be sodium hypophosphite (SHP), manganese hypophosphite, sodium phenylphosphinate, sodium phenylphosphonate, potassium phenylphosphinate, potassium phenylphosphonate, hexamethylenediammonium bis-phenylphosphinate, potassium tolylphosphinate, or mixtures thereof. In one aspect, the catalyst can be sodium hypophosphite (SHP).

The polyamide described herein can terminate in any suitable way. In some aspects, the polyamide can terminate with an end group that is independently chosen from a suitable polymerization initiator, —H, —OH, —CO₂H, —NH₂, CO₂⁻, —NH₃⁺, a substituted or unsubstituted (C₁-C₂₀) hydrocarbyl (e.g., (C₁-C₁₀) alkyl or (C₁-C₂₀) aryl) interrupted with 0, 1, 2, or 3 groups independently selected from —O—, substituted or unsubstituted —NH—, and —S—, a poly(substituted or unsubstituted (C₁-C₂₀) hydrocarbyloxy), and a poly(substituted or unsubstituted (C₁-C₂₀) hydrocarbylamino). The polyamide can be terminated by a combination composing of carboxylic acid (—CO₂H, —CO₂), amine (—NH₂, —NH₃) and acetyl (—COMe) end groups.

In some aspects, the foregoing modified nylon polymer may include acetic acid in an amount of about 1 to about 10,000 parts per million by weight (ppmw).

### Compounded Thermoplastic Resin.

The present invention provides a compounded thermoplastic resin. The compounded thermoplastic resin can include a) from ≥20 to ≤99 wt. % of a polyamide composition including a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent). The compounded thermoplastic resin can include b) up to ≤70 wt. % of a random copolymer composition. The compounded thermoplastic resin can include up to 50 wt. % of a co-polyamide of hexamethylene isophthalamide and hexamethylene terephthalamide (PA6I/6T). The compounded thermoplastic resin can optionally include up to 60 wt. % of a non-polyhexamethylene adipamide (non-PA66) component. The compounded thermoplastic resin is characterized by Melt Flow Index (MFI) of 10 to 80, melt temperature range of 245-265° C., and crystallization temp range of 195-220° C. The MFI is measured according to ISO Method 1133 for 0.325 kg sample weight having between 0.13 wt. % to 0.20 wt. % moisture at 275° C. test temperature. All wt. % values in parts a)-d) are based on the total mass of the compounded thermoplastic resin.

The RV can be determined without any glass fibers mixed with the polyamide, if they affect RV. Other methods of determining the RV other than from a 8.4 wt % polyamide solution in 90% formic acid, such as in a 1 wt. % solution in concentrated sulfuric acid, may be used and an appropriate correlation of RVs between the method used and the 8.4 wt. % in 90% Formic acid method, as used herein, can be determined. The RV measurements are typically performed at room temperature and atmospheric pressure.

The polyamide composition a) can have an amine end group (AEG) value in the range of ≥30 to ≤130 milliequivalents/kg (meq/kg). The polyamide composition a) can include any suitable polyamide, such as PA 46, PA 66, PA 69, PA 610, PA 612, PA 1012, PA 1212, PA 6, PA 11, PA 12, PA 66/6T, PA 6I/6T, PA DT/6T, PA 66/6I/6T or blends, such as PA6/PA66. The naming convention is well known in the art, for example, polycaproamide (PA6), polyhexamethylene decanamide (PA610), polyhexamethylene dodecanamide (PA612), polytetramethylene adipamide (N46), polyhexamethylene azelamide (PA69), polydecamethylene sebacamide (N1010), polydodecamethylene dodecanamide (N1212), nylon 11 (N11), polylaurolactam (N12), nylon 6T/DT. The polyamide composition a) can include or be polyhexamethylene adipamide (PA66).

The random copolymer composition b) can include at least one selected from: i) a copolymer of polyhexamethylene adipamide (PA66) and poly-2-methylpentamethylene isophthalamide (DI), wherein the mass ratio of copolymer (PA66/DI) is from 80:20 to 97:3; ii) a copolymer of polyhexamethylene adipamide (PA66) and poly-2-methylpentamethylene adipamide (D6), wherein the mass ratio of copolymer (PA66/D6) is from 70:30 to 90:10; iii) a copolymer of polyhexamethylene adipamide (PA66) and polyhexamethylene terephthalamide (6T), wherein the mass ratio of copolymer (PA66:6T) is from 75:25 to 55:45; and iv) a copolymer of poly-2-methylpentamethylene terephthalamide (DT) and poly-2-methylpentamethylene isophthalamide (DI), wherein the mass ratio of copolymer (DT/DI) is from 60:40 to 40:60. The random copolymer composition b) can optionally contain (as a part of the random copolymer composition) at least one of syndiotactic polystyrene (SPS), styrene-maleic anhydride (SMA) and imidized styrene-maleic anhydride (SMI).

The non-polyhexamethylene adipamide (non-PA66) component d) can include at least one selected from polycaproamide (PA6), polyheptanamide (PA7), polynonanamide (PA9), polyhexamethylene decanamide (PA610), polyhexamethylene dodecanamide (PA612), polytetramethylene adipamide (PA46), polytetramethylene sebacamide (PA410), polypentamethylene adipamide (PA56), polyhexamethylene azelamide (PA69), polypentamethylene sebacamide (PA510), polydecamethylene sebacamide (PA1010), polydecamethylene dodecanamide (PA1012), polypentamethylene dodecanamide (PA512), polydodecamethylene dodecanamide (PA1212), polyundecanamide (PA 11), polylaurolactam (PA12) and copolymer of poly-hexamethylene terephthalamide and poly-2-methylpentamethylene terephthalamide (PA6T/DT), poly-(2,2,4-/2,4,4)-trimethylhexamethylene terephthalamide (PAMe3-6T) and poly-meta-xylylene adipamide (PA-MXD6).

Non-PA66 components, such as homopolymers PA6, PA7, PA9, and PA56, PA510, PA512, PA410, PA610, PA1010 and PA1012; commonly referred to as PA5X, PAX10, PA4X, may either be produced from fossil-based monomers or bio-based monomers. For example, monomers 1,5-pentanediamine (for use in PA5X), 1,10-decamethylene diamine (for use in PA10X) and sebacic acid (for use in PAX10) are biobased monomers that have been used in synthesis and manufacture of many polyamide polymers and subsequent manufacture of articles consisting of such polyamides. In another example, PA11 is a well-known biobased polyamide produced by polymerization of 11-aminoundecanoic acid, a biobased monomer derived from castor oil. Biobased polymer can be a copolymer containing both fossil-based monomers and biobased monomers or can be copolymer of biobased monomers only.

The compounded thermoplastic resin can further include ≥0.1 to ≤2 wt. % heat stabilizer based on the total mass of the compounded thermoplastic resin.

The compounded thermoplastic resin can include i) a copolymer of polyhexamethylene adipamide (PA66) and poly-2-methylpentamethylene isophthalamide (DI), wherein the mass ratio of copolymer (PA66/DI) is from 80:20 to 97:3; ii) a copolymer of polyhexamethylene adipamide (PA66) and poly-2-methylpentamethylene adipamide (D6), wherein the mass ratio of copolymer (PA66/D6) is from 70:30 to 90:10; iii) a copolymer of polyhexamethylene adipamide (PA66) and polyhexamethylene terephthalamide (6T), wherein the mass ratio of copolymer (PA66:6T) is from 75:25 to 55:45; or a combination thereof.

The present invention provides a compounded thermoplastic resin. The compounded thermoplastic resin can include a) from ≥20 to ≤99 wt. %, based on the total mass of the compounded thermoplastic resin, of a polyamide composition including a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent). The compounded thermoplastic resin can include from ≥1 wt. % to ≤70 wt. %, based on the total mass of the compounded thermoplastic resin, of a copolymer of polyhexamethylene adipamide (PA66) and poly-2-methylpentamethylene isophthalamide (DI), wherein the mass ratio of copolymer (PA66/DI) is from 80:20 to 97:3. The compounded thermoplastic resin can optionally include c) up to 60 wt. %, based on the total mass of the compounded thermoplastic resin, of a non-polyhexamethylene adipamide (non-PA66) component. The time to peak crystallization of the compounded thermoplastic resin relative to that of polyhexamethylene adipamide (PA66) can slow down by a factor of ≥1.1 and ≤25 in the 140° C. to 220° C. temperature range. The time to peak crystallization can be determined using isothermal Fast Scanning Calorimetry (FSC) technique.

The polyamide composition including the polyamide having RV of from ≥20 to ≤50 can have an amine end group (AEG) value in the range of ≥30 to ≤130 milliequivalents/kg (meq/kg). The polyamide composition including the polyamide having RV of from ≥20 to 50 can be polyhexamethylene adipamide (PA66).

The present invention provides a compounded thermoplastic resin that can include from ≥20 to ≤99 wt. %, based on the total mass of the compounded thermoplastic resin, of a polyamide composition including a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent). The compounded thermoplastic resin can include from ≥1 wt. % to ≤50 wt. %, based on the total mass of the compounded thermoplastic resin, of a co-polyamide of hexamethylene isophthalamide and hexamethylene terephthalamide (PA6I/6T). The compounded thermoplastic resin can optionally include up to 60 wt. %, based on the total mass of the compounded thermoplastic resin, of a non-polyhexamethylene adipamide (non-PA66) component. The time to peak crystallization of the compounded thermoplastic resin relative to that of polyhexamethylene adipamide (PA66) can slow down by a factor of ≥1.1 and 50 in the 140° C. to 220° C. temperature range. The time to peak crystallization can be determined using isothermal Fast Scanning Calorimetry (FSC) technique. The polyamide composition including a polyamide having a relative viscosity (RV) of from ≥20 to ≤50 can have an amine end group (AEG) value in the range of ≥30 to ≤130 milliequivalents/kg (meq/kg). The polyamide composition including the polyamide having a relative viscosity (RV) of from ≥20 to ≤50 can be polyhexamethylene adipamide (PA66).

The compounded thermoplastic resin can any suitable peak crystallization slow-down factor, F_{slowdown}, such as a peak crystallization slow-down factor of ≥1.8 to ≤3.1; 3 to 11; or 1 to 15.

### Molding Composition.

The present invention provides a molding composition. The molding composition can include a first component including PA66 polyamide having RV from ≥20 to ≤50 measured at room temperature and pressure (RV determined from a 8.4 wt % polyamide solution in 90% formic acid and RV is the ratio of the viscosity of the polyamide solution to the viscosity of the solvent). The molding composition can include a second component including glass fibers where the cumulative number-averaged distribution of the glass fiber in the 0.5-5 mm linear length is ≥20% to ≤70% by weight, based upon total weight of glass fibers in the molding composition. The molding composition can include a third component selected from at least partially aromatic polyamides and at least partially branched aliphatic polyamides, the third component present in the molding composition at concentration sufficient to suppress molding fractures when a Direct Long Fiber Thermoplastic (DLFT) molding preform is pressed into a DLFT mold at temperature of from 240° C. to 265° C.

The second component can be present as ≥10 wt. % to ≤60 wt. % of the molding composition.

The third component can be present in the molding composition at concentration sufficient to suppressing molding fractures when a DLFT molding preform of dimensions 5×5×5 cm³ is pressed into a DLFT mold of dimensions 1 cm×11.18 cm×11.18 cm at molding composition temperature of 250° C. The third component can be present as ≥5 wt. % to ≤70 wt. % of the molding composition. The third component can include from ≥1 wt. % to ≤30 wt. % of one or more at least partially branched aliphatic polyamides, wherein the wt. % is based on the total weight of the third component. The third component can include from ≥1 wt. % to ≤100 wt. % of one or more at least partially aromatic polyamides, wherein the wt. % is based on the total weight of the third component. The third component can be present at concentration sufficient such that when then DLFT molding preform is pressed into a DLFT mold to produce an article having a form factor of from 2 to 5,000 m²/m³ specific surface area, the article is formed without structural defects (as defined herein) when the second component is present at concentration from ≥10 wt. % to ≤60 wt. %, based on the total weight of the molded composition. In various aspects, the weight ratio of the second component to the third component in the molding composition is from ≥0.1 to ≤15.

The present invention provides a molding composition that can include a first component including PA66 polyamide having RV from ≥20 to ≤50 measured at room temperature and pressure (RV determined from a 8.4 wt % polyamide solution in 90% formic acid and RV is the ratio of the viscosity of the polyamide solution to the viscosity of the solvent). The molding composition can include a second component including short glass fibers. The molding composition can include a third component selected from at least partially aromatic polyamides and at least partially branched aliphatic polyamides, the third component present in the molding composition at concentration sufficient to suppress molding fractures. The second component can be present as ≥10 wt. % to ≤60 wt. % of the molding composition. The third component can be present as ≥5 wt. % to ≤70 wt. % of the molding composition.

The molding composition can any suitable peak crystallization slow-down factor, F_{slowdown}, such as a peak crystallization slow-down factor of ≥1.8 to ≤3.1; 3 to 11; or 1 to 15.

### Compounded Polyamide Composition.

The present invention provides a compounded polyamide composition. The compounded polyamide composition can include PA66 or PA66/D6 or PA66/DI that is ≥20 to ≤99 wt % of the compounded polyamide composition. The compounded polyamide composition can also include a polymer additive that is up to ≤70 wt % of the compounded polyamide composition. The polymer additive can include a polyamide copolymer; a polymer including a repeating unit including a styrene reaction product; a polyamide formable via ring-opening polymerization; a polyamide including a repeating unit including a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6; or a combination thereof.

The PA66 or PA66/D6 or PA66/DI can be 25 wt % to 85 wt % of the compounded polyamide composition. The PA66 or PA66/D6 or PA66/DI can have an RV of 15-50, 20-50, or 20-45. The PA66 or PA66/D6 or PA66/DI can have an amine end group concentration of 30 meq/kg to 130 meq/kg, 30 meq/kg to ≤70 meq/kg, 65 meq/kg to 130 meq/kg, or 70 meq/kg to 125 meq/kg. The polymer additive can be 5 wt % to 70 wt % of the compounded polyamide composition or 15 wt % to 70 wt % of the compounded polyamide composition.

The polyamide copolymer can include a branched aliphatic condensation polyamide, a partially aromatic condensation polyamide, or a combination thereof.

The branched aliphatic condensation polyamide includes PA66/D6, PA66/DI, or a combination thereof. The branched aliphatic condensation polyamide can include PA66/DI. The PA66/DI can be 30 wt % to 70 wt % of the compounded polyamide composition, or 50 wt % to 70 wt % of the compounded polyamide composition. The PA66/DI can be 80 wt % to 99 wt % PA66 and 1 wt % to 20 wt % DI. The PA66/DI can be 90 wt % to 95 wt % PA66 and 5 wt % to 10 wt % DI. The PA66/DI can have an RV of 35 to 60, or 40 to 50. The PA66/DI can have an amine end group concentration of 40 meq/kg to 80 meq/kg. The PA66/DI can have an amine end group concentration of 60 meq/kg to 80 meq/kg.

The partially aromatic condensation polyamide can include PA66/6T, PA6I/6T, PADT/DI, or a combination thereof. The partially aromatic condensation polyamide can include PA6I/6T. The PA6I/6T can be 5 wt % to 40 wt % of the compounded polyamide composition, or 15 wt % to 30 wt % of the compounded polyamide composition. The PA6I/6T can be 1 wt % to 99 wt % PA6I and 1 wt % to 99 wt % 6T, or 20 wt % to 80 wt % PA6I and 20 wt % to 80 wt % 6T.

The polyamide formable via ring-opening polymerization can include PA6. The PA6 can be 5 wt % to 60 wt % of the compounded polyamide composition, or 20 wt % to 50 wt % of the compounded polyamide composition.

The polyamide including a repeating unit including a reaction product of H₂N—(CH₂)ₓ—NH₂ and HOC(O)—(CH₂)_{y}—C(O)OH can include a homopolymer. The polyamide including a repeating unit including a reaction product of H₂N—(CH₂)ₓ—NH₂ and HOC(O)—(CH₂)_{y}—C(O)OH can include PA610, PA612, or a combination thereof.

The polymer including a repeating unit including a styrene reaction product can include syndiotactic polystyrene (SPS). The polymer including a repeating unit including a styrene reaction product can include imidized styrene-maleic anhydride copolymer (SMI). The polymer including a repeating unit including a styrene reaction product can include styrene-maleic anhydride (SMA).

The polymer additive can include a branched aliphatic condensation polyamide; a partially aromatic condensation polyamide; syndiotactic polystyrene (SPS); imidized styrene-maleic anhydride copolymer (SMI); PA6; PA610; PA612; or a combination thereof. The polymer additive can include PA6I/6T; PA66/DI; PA6; or a combination thereof.

The compounded polyamide composition can further include a heat stabilizer. The heat stabilizer can be 0.1 wt % to 2 wt % of the compounded polyamide composition, or 0.1 wt % to 1.6 wt % of the compounded polyamide composition.

The compounded polyamide composition can have a melt flow index (MFI) of 10 to 36, or 12 to 30, or 12 to 25, all expressed in units of grams per 10 minutes, wherein the MFI is measured according to method ISO METHOD 1133 for 0.325 kg sample weight having between 0.13 wt. % to 0.20 wt. % moisture at 275° C. test temperature. The compounded polyamide composition can have a melt temperature of 230° C. to 260° C., 240° C. to 260° C., or 253° C. to 259° C. The compounded polyamide composition can have a crystallization temperature of 175° C. to 215° C., 185° C. to 210° C., or 190° C. to 210° C.

In various aspects, the compounded polyamide composition is substantially free of polyamides other than the PA66 or PA66/D6 or PA66/DI and the polymer additive. In various aspects, the compounded polyamide composition is substantially free of novoloc resins, reaction products of a polyhydric alcohol with a polyamide, polyesters, thermoplastic polyesters, or a combination thereof.

The present invention provides a compounded polyamide composition including PA66 or PA66/D6 or PA66/DI that is 25 wt % to 85 wt % of the compounded polyamide composition. The compounded polyamide composition can also include a polymer additive that is 5 wt % to 70 wt % of the compounded polyamide composition. The polymer additive can include PA66/DI, PA66/D6, PA6I/6T, PA6, or a combination thereof.

The compounded polyamide composition can have any suitable peak crystallization slow-down factor, F_{slowdown}, such as a peak crystallization slow-down factor of ≥1.8 to ≤3.1; 3 to 11; or 1 to 15.

The compounded polyamide composition can include one or more fillers, such as talc, mica, clay, silica, alumina, carbon black, wood flour, sawdust, wood shavings, newsprint, paper, flax, hemp, wheat straw, rice hulls, kenaf, jute, sisal, peanut shells, soy hulls, or combinations thereof.

The compounded polyamide composition can optionally include one or more additives such as adhesion promoters, biocides, anti-fogging agents, anti-static agents, anti-oxidants, bonding, blowing and foaming agents, catalysts, dispersants, extenders, smoke suppressants, impact modifiers, initiators, lubricants, nucleants, pigments, colorants and dyes, optical brighteners, plasticizers, processing aids, release agents, silanes, titanates and zirconates, slip agents, anti-blocking agents, stabilizers, stearates, ultraviolet light absorbers, waxes, catalyst deactivators, or combinations thereof.

The compounded polyamide composition can further include one or more flame retardant additives. The one or more flame retardant additives can be ≥5 to ≤30 wt. % of the compounded polyamide composition.

There exist flame retardant additives and flame retardant additive systems well known in the art. There exist broad classes of flame retardant additives and flame retardant additive systems, for instance and without limitation: halogen-containing flame retardants, halogen-containing flame retardants with synergists, phosphorus-containing flame retardants, inorganic flame retardants, nitrogen-containing flame retardants, nitrogen-containing flame retardants with synergists, these may be used alone or in combination. Plastics Additive Handbook, 5th Ed., Ed Hans Zweifel, Hanser, 2000, ISBN 1-56990-295-X, Chapter 12 speaks to the general topic and in Table 12.1 p 688 exemplifies typical flame retardant additive system and the levels of flame retardant additives used in polyamides. Plastic Additives, 4th Ed., ed R Gachter and H Miller, Hanser, 1993, ISBN 3-446-17571-7, Chapter 12 speaks to the general topic and in Table7 p 739 exemplifies flame retardant additives and the levels of flame retardant additives used in polyamides. Flame Retardants for Plastics and Textiles Practical Applications, Ed Edward D. Weil, Sergei V. Levchik. 2nd Edition, Hanser 2016, ISBN: 978-1-56990-578-4, Chapter 5, p 117 speaks to the topic of flame retardant additives and flame retardant additive systems for polyamides and exemplifies flame retardant additives and the levels of flame retardant additives used in polyamides throughout. Manufacturers and providers of flame retardant additives will often supply guidance on effective formulations, for instance, ICL Industrial Products Ltd produce such a guidance sheet for polyamides: Flame Retardants for Polyamides (General Application Data on Flame-Retardants for Polyamides 6 and 6,6), historically available at http://icl-ip.com/wp-content/uploads/2012/02/Polyamide-gnl-130729.pdf.

Halogen-containing flame retardant additives include, but not limited to: Brominated polystyrene; poly(dibromostyrene); poly(pentabromobenzylacrylate); Brominated polyacrylate; Brominated epoxy polymer; epoxy polymers derived from tetrabromobisphenol A and epichlorohydrin; Ethylene-1,2-bis(pentabromophenyl); Dechlorane Plus; chlorinated polyethylene; and mixtures of.

Halogen-containing flame retardant additives with synergists include, but not limited to: the halogen-containing flame retardant additive together with a synergist, such as but not limited to: antimony (III) oxide, antimony (V) oxide, sodium antimonate; iron (II) oxide, iron (II/III) oxide, iron (III) oxide, zinc borate, zinc phosphate, zinc stannate, and mixtures thereof.

Phosphorus-containing flame retardant additives include, but not limited to: red phosphorus, ammonium polyphosphate, melamine polyphosphate, melamine pyrophosphate, metal dialkylphosphinates (such as but not limited to aluminum methylethylphosphinate, and aluminum diethylphosphinate), aluminum hypophosphite, and mixtures thereof.

Inorganic flame retardant additives include, but not limited to: Magnesium Hydroxide, alumina monohydrate, alumina trihydrate, aluminum hydroxide, and mixtures thereof.

Nitrogen-containing flame retardant additives include, but not limited to: melamine cyanurate, melamine polyphosphate, melamine pyrophosphate, melamine, melan, and mixtures thereof.

Nitrogen-containing flame retardant additives with synergists include, but not limited to: nitrogen-containing flame retardant additives together with a synergist, such as but not limited to, Novalac resins.

Small amounts of polytetrafluoroethylene are often incorporated into the flame retardant additive system to retard dripping.

There are a variety of tests and standards that may be used to rate the flame retardant nature of a polymeric resin system. Underwriters' Laboratories Test No. UL-94 serves as one Industry Standard test for flame retardant thermoplastic compounds. “UL-94 Standard for Tests for Flammability of Plastic Materials for Parts in Devices and Appliances” gives details of the testing method and criteria for rating. The test method ASTM D635 is Standard Test Method for Rate of Burning and/or Extent and Time of Burning of Plastics in a Horizontal Position. The test method ASTM D3801 is Standard Test Method for Measuring the Comparative Burning Characteristics of Solid Plastics in a Vertical Position.

Other tests and instruments exist to rate flammability, such as but not limited to, the Limiting Oxygen Index (LOI) test (ASTM 2863); the cone calorimetry instrument (which measures amount and rate of heat release during combustion) ASTM E 1354 and ISO 5660-1Standards are both based upon this instrument; Glow Wire Flammability (IEC 60695-2-12); Glow Wire Ignition (IEC 60695-2-13).

Other tests which exist to rate flame retardancy include, and are not limited to, those where the rate of smoke generation, smoke obscuration, the toxicity of smoke and combustion gases, are determined. Other tests exist to rate flame retardancy which are application specific, these include but are not limited to applications such as: apparel fabrics, upholstery fabrics, airbag fabrics, carpets, and/or rugs.

### Fiber-Compounded Polyamide Composition.

The present invention provides a fiber-compounded polyamide composition. The fiber-compounded polyamide composition can include the compounded polyamide composition of the present invention described herein. The fiber-compounded polyamide composition also includes a reinforcing fiber.

The reinforcing fiber can be 10 wt % to 60 wt % of the fiber-compounded polyamide composition, or 25 wt % to 50 wt % of the fiber-compounded polyamide composition, or 15 wt. % to ≤55 wt. %, ≥20 wt. % to ≤40 wt. %, 25 wt. % or 30 wt. % or 35 wt. % or 40 wt. % or 45 wt. % or 50 wt. % reinforcing fibers. The reinforcing fiber can include carbon fibers, carbon nano-fibers, glass fibers, basalt fibers, natural fibers, mineral fibers, nano-cellulosic fibers, wood fibers, non-wood plant fibers, or a combination thereof. The reinforcing fiber can include glass fibers.

At least 25% of the reinforcing fiber can have a length ≥0.5 mm, as determined via number-averaged fiber length. An amount of 25-68% of the reinforcing fiber can have a length ≥0.5 mm, as determined via number-averaged fiber length. The reinforcing fiber can be glass fibers, and at least 25% of the reinforcing fiber can have a length ≥0.5 mm, as determined via number-averaged fiber length.

The fiber-compounded polyamide composition can be an extruded sheet, an extruded pellet, a compression molded article, or an injection molded article.

The present invention provides a fiber-compounded polyamide composition that can include a compounded polyamide composition that is 40 wt % to 90 wt % of the fiber-compounded polyamide composition. The compounded polyamide composition can include PA66 that is 25 wt % to 85 wt % of the compounded polyamide composition. The compounded polyamide composition can also include a polymer additive that is 5 wt % to 70 wt % of the compounded polyamide composition. The polymer additive can include PA66/DI, PA66/D6, PA6I/6T, PA6, or a combination thereof. The fiber-compounded polyamide composition can also include glass fibers that are 10 wt % to 60% of the fiber-compounded polyamide composition, wherein at least 25% of the glass fibers have a length ≥0.5 mm as determined via number-averaged fiber length.

The fiber-compounded polyamide composition can any suitable peak crystallization slow-down factor, F_{slowdown}, such as a peak crystallization slow-down factor of ≥1.8 to ≤3.1; 3 to 11; or 1 to 15.

### Article.

The present invention provides an article that includes the compounded thermoplastic resin, the molding composition, molding composition, compounded polyamide composition, or fiber-compounded polyamide composition of the present invention described herein. The article can be any suitable article. The article can be a molded article or an extruded article. For example, the article can be a vehicular battery housing or tray; an impeller; a vehicular tire trunk or tire compartment; an enclosure; a circular wheel rim; or a combination thereof.

The present invention provides an article including the molding composition of the present invention described herein. The article can be any suitable article. For example, the article can be a vehicular radiator component; a vehicular duct; a vehicular tank; an electrical connector box; an electrical junction box; electronics hardware; or a combination thereof.

### Molded Article.

The present invention provides a molded article. The molded article can be any suitable molded article prepared from the compounded thermoplastic resin, the molding composition, molding composition, compounded polyamide composition, or fiber-compounded polyamide composition of the present invention described herein. The molded article can be substantially free of reinforcing fiber, or the molded article can include reinforcing fiber.

The molded article can include ≥10 wt % to ≤60 wt % reinforcing fiber, based on the total weight of the article. The reinforcing fiber can be selected from the group consisting of carbon fiber, carbon nano-fiber, short glass fiber, long glass fiber, basalt fiber, natural fiber, mineral fiber, nano-cellulosic fiber, wood fibers, non-wood plant fibers, and combinations thereof. The reinforcing fiber can be a glass fiber. The molded article can include glass fiber, and the amount of the glass fiber, based on the total weight of the article, can be selected from ≥10 wt. % to ≤60 wt. %, ≥20 wt. % to ≤55 wt. %, and ≥25 wt. % to ≤50 wt. %. The cumulative number-averaged distribution of the glass fiber in the 0.5-5 mm linear length can be ≥20% to ≤70% by weight, based on the total weight of the article.

The present invention provides a molded article formed from the compounded polyamide composition of the present invention described herein. The molded article can be substantially free of reinforcing fibers. The molded article can include reinforcing fibers.

The molded article can have a tensile strength in a length-wise direction of 150 MPa to 300 MPa, or 165 MPa to 270 MPa, as measured on a sample having less than 0.2 wt % water. The molded article can have an elongation at break in a length-wise direction of 1% to 10%, or 2.5% to 4.5%, as measured on a sample having less than 0.2 wt % water. The molded article can have a tensile modulus in a length-wise direction of 5,000 MPs to 25,000 MPa, or 6,500 MPa to 18,000 MPa, as measured on a sample having less than 0.2 wt % water. The molded article can have a 23° C. unnotched Charpy impact strength in a length-wise direction of 35 kJ/m² to 100 kJ/m², 45 kJ/m² to 80 kJ/m², 15 kJ/m² to 35 kJ/m², or 17 kJ/m² to 27 kJ/m², as measured on a sample having less than 0.2 wt % water. The molded article can have a tensile strength in a cross-wise direction of 35 MPa to 120 MPa, or 45 MPa to 100 MPa, as measured on a sample having less than 0.2 wt % water. The molded article can have an elongation at break in a cross-wise direction of 0.5% to 3.5%, or 1% to 2.8%, as measured on a sample having less than 0.2 wt % water. The molded article can have a tensile modulus in a cross-wise direction of 3,000 MPa to 10,000 MPa, or 4,000 MPa to 8,000 MPa, as measured on a sample having less than 0.2 wt % water. The molded article can have a 23° C. unnotched Charpy impact strength in a cross-wise direction of 8 kJ/m² to 30 kJ/m², 10 kJ/m² to 22 kJ/m², 4 kJ/m² to 20 kJ/m², or 6 kJ/m² to 11 kJ/m² as measured on a sample having less than 0.2 wt % water.

The molded article can be an automotive part. The molded article can be an automotive part including an automotive structural component, a battery case, a battery tray, a dashboard carrier, a front-end, a bumper, a bumper carrier, an underfloor component, an oil pan, a spare wheel recess, an underbody component, an underbody shield, or a combination thereof.

### Method of Making a Compounded Thermoplastic Resin.

The present invention provides a method of making the compounded thermoplastic resin of the present invention described herein. The method can include a) feeding to a compounding zone (e.g., of an extruder) a polyamide, a random copolymer, a co-polyamide of hexamethylene isophthalamide and hexamethylene terephthalamide, and a heat stabilizer. The method can include b) maintaining conditions in the compounding zone to blend the contents to form a homogeneous compounded thermoplastic resin melt. The method can include c) recovering the compounded thermoplastic resin melt from step b). The method can also include d) producing extrudate from step c)'s compounded thermoplastic resin melt. The compounded thermoplastic resin can be characterized by a Melt Flow Index (MFI) of 10 to 80. The MFI can be measured according to ISO Method 1133 for 0.325 kg sample weight having between 0.13 wt. % to 0.20 wt. % moisture at 275° C. test temperature. Method of forming compounded polyamide composition.

The present invention provides a method of making the compounded polyamide composition of the present invention described herein. The method can include feeding a composition including PA66 and a polymer additive to a compounding zone (e.g., of an extruder). The polymer additive can include a polyamide copolymer; a polymer including a repeating unit including a styrene reaction product; a polyamide formable via ring-opening polymerization; a polyamide including a repeating unit including a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6; or a combination thereof. The method can include maintaining conditions in the compounding zone to blend the composition to form a melted compounded polyamide composition. The method can also include producing extrudate from the melted compounded polyamide composition to form the polyamide composition.

### Method of Forming a Molded Article.

The present invention provides a method of forming the molded article of the present invention described herein. The method can include placing the compounded polyamide composition of the present invention described herein into a mold to form the molded article. The method can also include removing the molded article from the mold.

The method can include an extruded sheet of the compounded polyamide composition of the present invention into the mold. The method can include placing the fiber-compounded polyamide composition of the present invention into a mold to form the molded article. The method can include melting the compounded polyamide composition of the present invention and combining the melt with reinforcing fibers to form the fiber-compounded polyamide composition of the present invention, and placing the fiber-compounded polyamide composition into the mold.

The method can be a compression molding process. The method can further include compressing the compounded polyamide composition or the fiber-compounded polyamide composition in the mold.

The method can be a method of direct long fiber thermoplastic molding (D-LFT) or long fiber thermoplastic direct molding (LFT-D).

### Method of Improving D-LFT or LFT-D of a Fiber-Compounded Polyamide Composition.

The present invention provides a method of improving direct long fiber thermoplastic molding (D-LFT) or long fiber thermoplastic direct molding (LFT-D) of a fiber-compounded polyamide composition. The method can include including a sufficient amount of polymer additive in the fiber-compounded polyamide composition such that a lower melt flow index, melt temperature, crystallization temperature, or combination thereof, is achieved. The fiber-compounded polyamide composition including the polymer additive can include a compounded polyamide composition including PA66 that is ≥20 to ≤99 wt % of the compounded polyamide composition; a polymer additive that is ≥1 to ≤70 wt % of the compounded polyamide composition; and reinforcing fibers that are 10 wt % to 60% of the fiber-compounded polyamide composition. The polymer additive can include a polyamide copolymer, a polymer including a repeating unit including a styrene reaction product, a polyamide formable via ring-opening polymerization, a polyamide including a repeating unit including a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6, or a combination thereof.

The problem of PA66 in D-LFT molding processing is solved in one aspect by providing modified PA66 compositions that include PA66/DI and/or PA66/D6 materials. Such compositions may be suitable in D-LFT molding applications for making large form factor light-weight molded parts; battery tray and compartments for EV markets being some of the industrially relevant examples.

As a non-limiting illustration according to the present disclosure, a battery tray for an electric vehicular power system is molded using the modified PA66 compositions by D-LFT molding process. Such molded battery tray has desired properties of housing the battery assembly while preventing water invasion/damage, battery cell heat management and battery cell temperature maintenance for enhanced charge storage capacity, strength and durability/life of the EV battery unit.

Other examples of large form factor parts suitable for the present invention include bicycle wheels and chairs.

Such large form-factor and light-weight molded parts, prepared according to the present disclosure, typically have high surface areas per unit volume or per unit weight. A commonly used parameter is either weight-specific surface area or volume-specific surface area of the molded part or article. The weight-specific surface area is the ratio of the surface area of molded part to its weight, and the units of measurement can be cm²/g or m²/kg or ft²/lb, and the like. The volume-specific surface area is the ratio of the surface area of molded part to its volume, and the units of measurement can be cm²/cm³ or m²/m³ or ft²/ft³, and the like.

Non-limiting examples of conventional injection molding of compounded polymers may include extrusion molding, blow molding, press molding, compression molding, gas assisted molding, and the like. See U.S. Pat. Nos. 8,658,757; 4,707,513; 7,858,172; 8,192,664.

### EXAMPLES

Various aspects of the present disclosure can be better understood by reference to the following Examples which are offered by way of illustration. The present disclosure is not limited to the Examples given herein.

Unless otherwise stated, the term “RV”, used in the Examples, refers to relative viscosity of a polymer sample as measured in an 8.4 wt. % solution in 90% formic acid at room temperature and atmospheric pressure. The RV is the ratio of the viscosity of the solution to the viscosity of the solvent used. The solution is 8.4 wt. % polyamide solution in 90% formic acid. Formic acid is the solvent used.

In the below examples, all are mass or weight ratios and weight percentages (wt. %) unless otherwise stated.

### Test Materials Used.

The following materials are used:

The term “SPS” refers to a commercially available semi-crystalline polymer class known as Syndiotactic Polystyrene.

The term “SMA” refers to a commercially available styrene-maleic anhydride copolymer (CAS Number: 9011-13-6).

The term “SMI” refers to an imidized styrene-maleic anhydride copolymer.

The terms “nylon-6”, “Polyamide 6”, “PA6”, “N6” are used interchangeably and refer to polycaproamide, which is a homo-polyamide formed from caprolactam.

The terms “nylon-6,6”, “Polyamide 66”, “PA66”, “N66”, “nylon 6-6” or “nylon 6/6” are used interchangeably and refer to polyhexamethyleneadipamide, which is a polyamide formed by polycondensation reaction between hexamethylene diamine (HMD) and adipic acid (AA).

As used herein, “PA66 (20-36 RV)” refers to a polyhexamethylene adipamide having a relative viscosity (RV) of from 20 to 36. Such polyamides are described in International Patent Publication No. WO2019/125379A1 and commercially available under the trademark of HYPERFLOW™ Polyamide from INVISTA Intermediates.

As used herein, “High AEG PA66” refers to a polyhexamethylene adipamide having a relative viscosity (RV) of at least 35 or 40 or 45, as determined via a formic acid method, and amine-end group (AEG) range of ≥65 milliequivalents/kg (meg/kg) and ≤130 meq/kg, for example, ≥70 milliequivalents per kg (meq/kg) and ≤125 meq/kg. The high-AEG PA66 used in the examples has 39 RV and AEG of 92 meg/kg. The amine end group (AEG) numbers are measured by titration of polymer solution in solvent such as methanol/phenol. Used interchangeably, the units of AEG are either milliequivalents/kg of sample (meg/kg) or moles per million grams of sample (mpmg).

As used herein, the term “INVISTA U4803 PA66” is a general purpose, c.a. 48 RV, natural PA66 resin suitable for compounding, injection molding, and extrusion applications where ease of processing, good color, and physical property retention are desired. Its product information is available at https://nylonpolymer.invista.com/-/media.

As used herein, “PA66/DI” refers to a type of co-polyamide formed by combining PA66 salt solution with DI salt solution, where “D” is an abbreviation for 2-methyl-1,5-pentamethylene diamine (also known as MPMD), and “I” is an abbreviation for isophthalic acid that is commercially available. Standard batch evaporation and batch autoclave polymerization processes are used to produce the copolymer. These methods are polymerization processes generally known to the skilled person.

MPMD is commercially available under a registered trademark to INVISTA S. a r. 1. as DYTEK® A Amine (CAS Registry Number 15520-10-2). INVISTA DYTEK® A amine is commercially produced by hydrogenating 2-methylglutaronitrile (or “MGN”). MGN is a branched C6 dinitrile obtained as a side-product from butadiene double-hydrocyanation process of adiponitrile (or “ADN”) manufacture. The otherwise disposed MGN side-product can be recycled and reused in the production of INVISTA DYTEK® A amine or the “D” portion; the PA66/DI produced by this process, therefore, is considered to have the recycled amine content coming from the “D” portion. The “D” containing compounded resins of the present disclosure are considered to contain the recycled amine content.

PA66/DI may contain about 80-99% PA66 and about 1-20% DI on the mass basis, for example, about (on wt:wt basis) 99:1 or 97:3 or 95:5 or 92:8 or 90:10 or 85:15 or 80:20 for PA66:DI achieved for the salts on dry basis. The “DI” part in PA66/DI is about 50:50 (molar) or about 40:60 D:I (mass ratio). PA66/DI is known as a copolymer of hexamethylene adipamide and 2-methyl-1,5-pentamethylene-isophthalamide. PA66/DI used in the examples has a relative viscosity (RV) of 45. However, the RV range for PA66/DI can be between 35 and 60 and may contain amine end groups (AEG) between 40 to 80 meg/kg, for example, between 60 to 80 meg/kg, or 65 meg/kg, or 70 meg/kg.

As used herein, “PA66/D6” refers to a type of co-polyamide formed by combining PA66 salt solution with D6 salt solution, and having about (on wt:wt basis) 90/10 or 87/13 or 85/15 or 82/18 or 80/20 or 75/25 or 70/30 for PA66/D6 achieved for the salts on dry basis. Standard batch evaporation and batch autoclave polymerization processes are used to produce the copolymer. The diacid equivalent is adipic acid, abbreviated as “6” and used with the same diamine “D” described above.

In various aspects, a copolyamide PA66/D6 (70/30) can be made by combining PA66 salt solution with D6 salt solution and using a 70/30 mass ratio for the salts on dry basis. Standard batch evaporation and batch autoclave polymerization processes can be used to produce the copolymer. The diacid equivalent can be adipic acid; a six-carbon dicarboxylic acid.

In various aspects, the disclosures herein pertain to a modified nylon including random copolymers of PA66/DI with D substitution for HMD at 5 to 15 mol % and isophthalic acid (I) substitution for adipic acid at 5 mole % to 15 mole % and having slower crystallization rates than PA66 homopolymer, and can provide improved surface appearance and gloss in extruded and molded parts.

As used herein, “PA66/6T” refers to a co-polyamide formed by combining PA66 salt with hexamethylene terephthalamide, abbreviated as “6T”. The compositional ranges for PA66/6T may be from 55:45 to 75:25 (mole ratios), for example, 70:30 or 65:35 or 60:40 (all mole basis).

As used herein, “PA6I/6T” refers to a co-polyamide formed by combining a salt of hexamethylene diamine and isophthalic acid, abbreviated as “I”, with that of hexamethylene diamine and terephthalic acid, abbreviated as “T”. PA6I/6T is also known as a copolyamide of hexamethylene isophthalamide and hexamethylene terephthalamide. PA6I/6T nylon copolymer is commercially available from EMG-Grivory under the tradename Grivory® G16, G21, and the like. EMS Grivory® G21 nylon copolymer is a medium RV grade of PA6I/6T (2:1). EMS Grivory® G16 nylon copolymer is a low RV grade of PA6I/6T (2:1). Its product information is publicly available at https://www.emsgrivory.com/en/ems-material-database.

As used herein, “PA DT/DI” or “DT/DI” refers to a co-polyamide formed by combining a salt of 2-methyl-1,5-pentamethylene diamine (MPMD or “D”) with terephthalic acid “T” with that of 2-methyl-1,5-pentamethylene diamine (MPMD or “D”) with isophthalic acid “I”. The compositional ranges for PA DT/DI may be from 40:60 to 60:40 (mass ratios), for example, 45:55 or 48:52 or 50:50 or 55:45 (all mass basis). DT/DI is described in the U.S. Pat. No. 10,711,104.

As interchangeably used herein, “PA610” or “nylon-6,10” or “N610” or “N6/10” is a semi-crystalline polyamide prepared from hexamethylenediamine (C6 diamine, abbreviated as HMD) and decanedioic acid (C10 diacid). It is commercially available from Arkema, BASF, and such.

As interchangeably used herein, “PA612” or “N612” or “N6/12” is commercially available from DuPont, EMS, Shakespeare, Nexis. PA612 is a semi-crystalline polyamide prepared from hexamethylenediamine (C6 diamine, abbreviated as HMD) and dodecanedioic acid (C12 diacid, abbreviated as DDDA).

In the present disclosure, the term “glass fiber” is abbreviated as “GF” which is understood to be a standard nomenclature in the polymer and compounding industry. The amount of GF in the polymer sample is represented as wt. % of the total, unless stated otherwise.

Non-limiting examples of various commercially available flame retardant additives may include, BASF Melapur™ MC25 halogen-free flame retardant; Mastertek® antimony trioxide concentrate masterbatches from Campine NV; Clariant Exolit® OP1314 or OP1400 non-halogenated organic phosphinate flame retardant; Presafer (Quingyuan) Phosphor Chemical Co. Ltd. Preniphor™ EPFR-MPP300 halogen-free, melamine polyphosphate flame retardant; Albemarle SAYTEX® HP 7010 bromine-based flame retardant; Campine PA 261717 50% masterbatch of antimony trioxide (CAS No 1309-64-4) in Nylon 6; Borax Europe Ltd Firebrake® 500 dehydrated zinc borate based fire retardant, or combinations thereof.

As used herein, melting point (MP) is the endothermic peak which occurs during heating of small samples in a differential scanning calorimeter (DSC) (ASTM D3417, ISO 11357). As used herein, melt viscosity (MV) is an indicator of the melt flow characteristic of a resin as measured in Pascal seconds (Pa sec) with a Kayness Capillary Rheometer measured at 280° C. under constant force conditions. Molecular weight of polyamide resins is typically inferred by the measurement of solution viscosity. The two most common methods are: (i) ASTM D789 for relative viscosity (RV) measurement, and (ii) ISO 307 using sulfuric acid to obtain viscosity number (VN) values. Viscosity values and trends to be considered are determined by the same method, regardless of which method is selected.

Test methods. ASTM D789: formic acid solution relative viscosity. ISO 527: tensile modulus (MPa) testing of molded and extruded plastics. ISO 527: % elongation-at-break testing of materials. ISO 179: Charpy impact strength (23° C., kJ/m²). ISO 11357: differential scanning calorimetry (DSC) for melting temperatures and crystallization temperatures of plastics.

### PA66/DI and PA66/D6 Preparations.

According to the conventional batch autoclave method employed herein, a 40-60% polyamide salt solution formed from substantially equimolar amounts of diacid and diamine in water, is charged into a pre-evaporator vessel operated at a temperature of about 130-160° C. and a pressure of about 180 to about 690 kPa absolute, wherein the polyamide salt solution is concentrated to about 70-80%. This concentrated solution is transferred to the autoclave, where heating is continued as the pressure in the vessel rises to about 1100 to about 4000 kPa absolute. Steam is vented until the batch temperature reaches about 220-260° C. The pressure is then reduced slowly (over about 30-90 minutes) to about 100 kPa absolute or lower. The polymer molecular weight is controlled by the hold time and pressure at this stage. Salt concentration, pressure, and temperature may vary depending on the specific polyamide being processed. After the desired hold time, the polyamide is then extruded into strand, cooled, and cut into pellets (also known as granulates).

In this batch process, a phosphorus compound or other additive may be introduced before polymerization (e.g., into a solution of at least one polyamide-forming reactant), or can be introduced at any point during polymerization, or can even be introduced post-polymerization (e.g., by incorporating the phosphorus compound and the base into a polyamide melt, using conventional mixing equipment, such as an extruder). The phosphorus compounds and additives can be introduced separately or all at once. As a means for protection against oxidation and thermal degradation, the phosphorus compound and additives are provided early in the polymerization process, such as at the beginning of the polymerization process. Additives which may be in solid form can be provided as solids or in the form of aqueous solutions.

### Crystallization Behavior of Resins.

The crystallization behavior of several test specimens, according to the present disclosure, was determined using Fast Scanning Calorimetry (FSC). Both, isothermal and non-isothermal crystallization behaviors were determined using the FSC technique. Published research articles titled “Sensitivity of Polymer Crystallization to Shear at Low and High Supercooling of the Melt”, Macromolecules, 2018, 51, 2785-2795, and “Probing Three Distinct Crystal Polymprphs of Melt-Crystallized Polyamide 6 by an integrated Fast Scanning Calorimetry Chip System”, Marcomolecules, August 2021, describe the FSC technique in detail.

The FSC, also known as flash DSC, technique is similar to standard DSC except it operates at much faster heating and cooling rates of the order of from 0.1 to 5000° C./sec. Also, the sample mass is 100,000× smaller than the standard DSC method. Thus, the cooling rates can mimic those experienced at the surface or any depth from the surface as the part is being molded.

### Example 1. Injection Molded Articles Made from PA66/DI and PA66/D6

Polymer compositions of PA66/D6 (82/18) and PA66/DI (92/8) exhibit melting temperature (ISO 11357 method by DSC) of approximately 245° C., compared to approximately 262° C. for PA66. A sample of PA66/6 (91.3/8.7) also shows melting temperature of approximately 245° C. These materials were molded into plaques and test specimens by injection molding trials. The measured mechanical properties are similar for PA66/D6 (82/18), PA66/DI (92/8), and PA66/6 (91.3/8.7). The values in the parenthesis are mass ratios of the respective constituents present in polymer compositions. For example, the term “PA66/6 (91.3/8.7)” means the mass ratio of PA66: PA6 is 91.3:8.7 (totaling 100%). Likewise, the term “PA66/DI (92/8)” means the mass ratio of PA66: DI is 92:8 (totaling 100%), and so on.

The polymer composition PA66/D6 (70/30) has roughly 15 wt. % comonomer content of “D”, with a melting temperature of approximately 230° C. When used in a 50 wt. % glass-fiber reinforced resins, injection molded plaques show better smoothness and gloss with PA66/D6 (70/30) polymer than with PA66/6 (91.3/8.7) polymer.

Tables 1 and 2 illustrate the desirable molded article properties for PA66/DI and PA66/D6 polymers and resins.

TABLE 1

| | Notched | | Tensile | | Tensile | Tensile | |
|---|---|---|---|---|---|---|---|
| Resin | Charpy, | St. | Strength | St. | Yield | Break | Modulus |
| Specimen | kJ/m² | Dev | (MPa) | Dev | Strain | Strain | (MPa) |
| PA66/DI | 4.4 | 0.2 | 81.7 | 0.6 | 5.7% | 27% | 2112 |
| (92/8) | | | | | | | |
| PA66/D6 | 4.0 | 0.1 | 81.1 | 0.2 | 5.2% | 29% | 2162 |
| (82/18) | | | | | | | |

TABLE 2
Glass Filled 50% “GF50” Resin properties

| | | | Notched | Unnotched | Tensile | Tensile | Tensile | |
|---|---|---|---|---|---|---|---|---|
| Polymer for | Tc | Tm | Charpy, | Charpy, | strength, | Break | Modulus, | Gloss at |
| GF50 Resin | (° C.) | (° C.) | kJ/m² | kJ/m² | (MPa) | Strain | (MPa) | 60° angle |
| PA66/DI | 196 | 245 | 18 | 114 | 258 | 3.2% | 17124 | 50 |
| (92/8) | | | | | | | | |
| PA66/D6 | 202 | 248 | 17 | 117 | 256 | 3.0% | 16640 | nd |
| (82/18) | | | | | | | | |

Tm is melt-point temperature;
TC is crystallization point temperature:
nd Not Determined.

### Examples 2A-F

Table 3 below shows several compoundable thermoplastic resin compositions prepared according to the present disclosure. All values are weight basis, unless otherwise mentioned.

TABLE 3

| | | | Example | Example | Example | Example | Example | Example |
|---|---|---|---|---|---|---|---|---|
| Component | Range (%) | | 2A | 2B | 2C | 2D | 2E | 2F |
| PA66 (25 RV) | ≥20 | to ≤99 | 98.5 | 68.95 | 78.8 | 59.1 | 29.55 | — |
| PA66/DI (45 RV) | up | to ≤70 | — | — | — | — | 68.95 | — |
| High AEG | ≥20 | to ≤99 | | | | | | 98.5 |
| PA66 (39 RV, | | | | | | | | |
| 92 AEG) | | | | | | | | |
| PA61/6T | Up | to ≤50 | — | 29.55 | 19.7 | — | — | — |
| (EMS Grivory ® | | | | | | | | |
| G21) | | | | | | | | |
| Non-PA66 | Up | to ≤60 | — | — | — | 39.4 | — | — |
| PA6 | | | | | | | | |
| Heat stabilizer | ≥0.5 | to ≤2 | 1.5 | 1.5 | 1.5 | 1.5 | 1.5 | 1.5 |

| | | | | | | | |
|---|---|---|---|---|---|---|---|
| CuI/KI | | | | | | | |
| Masterbatch | | | | | | | |
| in PA6 (2% | | | | | | | |
| CuI, 10% KI) | | | | | | | |
| and also | | | | | | | |
| including | | | | | | | |
| Non-PA66 | | | | | | | |
| TOTAL | | 100 | 100 | 100 | 100 | 100 | 100 |
| Melt Flow | | 36.8 | 14.7 | 22.1 | 24.1 | 11.7 | Not |
| Index (MFI)* | | | | | | | measured |
| Melt | | 262 | 256 | 258 | 255 | 253 | |
| Temperature, | | | | | | | |
| Tm (° C.) | | | | | | | |
| Crystallization | | 217 | 195 | 206 | 203 | 200 | |
| Temp, Tc (° C.) | | | | | | | |
| Enthalpy | ΔH, J/g | 66.9 | 51.4 | 51.1 | 49.8 | 62.0 | |
| Change | | | | | | | |
| during 2nd | | | | | | | |
| DSC cooling | | | | | | | |
| (crystallization), | | | | | | | |

*in grams/10 min., measured for samples with 0.13-0.20 wt. % moisture, 275° C. test temperature, 0.325 kg sample weight. Test method—ASTM D 1238, ISO 1133.

DSC—Differential scanning calorimetry—A Perkin-Elmer DSC analytical instrument was used for measuring the DSC data for Table 3 test specimens. About 6-7 mg sample of each test specimen was run in duplicate using the following temperature ramp-ups, ramp-downs (rates in ° C./min), and isothermal holds (at ° C. for the stated time in minutes) in between:
1st Heat—heat from 30° C. to 300° C. at 20° C./min;
Isothermal—Hold at 300° C. for 1 min;
1st Cool—Cool from 300° C. to 100° C. at 50° C./min;
Isothermal—Hold at 100° C. for 1 min;
2nd Heat—Heat from 100° C. to 300° C. at 10° C./min;
2nd Cool—Cool from 300° C. to 100° C. at 50° C./min.

For each DSC-tested sample, the melt point temperature (Tm in ° C.) was determined from the DSC trace for Heat Flow (endothermic 2nd Heat ramp-up) plotted as a function of the temperature. The crystallization temperature (Tc in ° C.) and Enthalpy Change (ΔH, Joules/g) during cooling (crystallization) were determined from the DSC trace for Heat Flow [exothermic 1st Cool ramp-down] plotted as a function of the temperature. The melt point temperature (Tm in ° C.), crystallization temperature (Tc in ° C.) and Enthalpy Change (ΔH, Joules/g) during 2nd cooling (crystallization) data were arithmetically averaged from the two-run measurements and are shown in Table 3.

### Example 3. Compression Molding Using Compounded Resins of Examples 2(A-F)

The compounded thermoplastic resins, as described in Table 3, are processed through a conventional injection molding equipment. It is observed that the Table 3 compounded blends allow for a wider processing window as compared to the nylon 66 material. It is also observed that these blends are suitable to produce large form factor molded parts having good dimensional tolerances.

In an illustrative example, some of the compounded thermoplastic resin extrudates of Table 3 compositions are molded into 1 m×0.5 m×3-4 mm flat plate specimens using D-LFT molding process. No significant processing issues are encountered. Some of the unexpected observations noticeable during this process are represented in Table 4 below.

TABLE 4

| | Compounded Thermoplastic Resin | | |
|---|---|---|---|
| | according to . . . | | |
| Observed Effect during | Example | Example | Example |
| D-LFT molding of . . . | 2A | 2B | 2E |
| Processability | + | +++ | ++ |
| Rheology (viscosity effects) | + | +++ | ++ |
| on the D-LFT machine | | | |
| Glass Fiber incorporation | 30-50 wt. % | 30-50 wt. % | 30-50 wt. % |

“+” is baseline performance. “++” and “+++” are relatively better than baseline performance.

It is surprisingly and unexpectedly found that the Table 3 compounded resins allow for:
higher than 40% (by weight) glass fiber incorporation, thereby making molded parts of improved mechanical properties.
processing at lower than typical molding temperatures for PA66, i.e., in the 240-265° C. range, thereby minimizing thermal degradation/oxidation and mechanical defects in the finished product.

### Example 4. Large Molded Parts from Compounded Resins of Examples 2(A-F)

Large articles are molded using the compounded resin extrudates of Examples 2(A-F) and D-LFT molding process. The prototype articles include an impeller for fluid transport applications, hold tray for multiple battery cell applications, bicycle wheel rims, and tire trunk.

The large articles made from these polyamide copolymers have improved processability and mechanical strength properties in comparison with homopolymer PA66 as well as acceptable performance versus their requirements for use in high-impact and stress-inducing applications.

### Example 5: Variations of Examples 2(A-F) Compounded Resins

Non-limiting suitable resin candidates that may replace Table 3 constituent labeled “PA66/DI (45 RV)” in the compounded compositions include PA66/D6 (mass ratio of 82/18 as in Example 1), PA66/6T (selected from the mass ratios of 75/25, 70/30, 65/35, 60/40 and 55/45), PA610, PA6T/6I, PADT/DI, SPS, SMI, and combinations thereof. The loading of such candidate resin in the total compounded resin is up to 70% (by wt.).

### Example 6. Variations of Examples 2(A-F) Compounded Resins

Non-limiting suitable candidates that may replace Table 3 constituent labeled “Non-PA66” in compounded compositions include PA6, PA610, PA612 and combinations thereof. The loading of such non-PA66 candidate resin in the total compounded resin is up to 60% (by wt.).

### Example 7. Variations of Examples 2(A-F) Compounded Resins with Glass Fiber Reinforcement During D-LFT Molding

In this example, several Table 3 compositions underwent D-LFT molding process, wherein a commercially available glass fiber [TUFROV® 4510 Glass Fiber from PPG Industries] of 1-inch (25.4-mm) length was used. The PPG's TUFROV® 4510 Glass Fiber Data Sheet states 2.58 g/cm3 density and 12-μm filament diameter. The glass fiber is compatible with polyamides. The glass fiber content in the specimens was in the range from 30-50 wt. % of the total.

In a general D-LFT manufacturing process layout, a granulated thermoplastic resin material along with the additives was fed to the extruder front and the resultant resin melt was blended with a roving material (e.g.: glass fiber, carbon fiber, natural fibers, and the like) before entering an LFT unit. A non-limiting example of such LFT unit is commercially available Dieffenbacher LFT-D technology [official website: www.Dieffenbacher.com/en/composites/technologies/lft-long-fiber-thermoplast], and for example, Compounder Models Leistritz ZSE 60 GL 24D or Leistritz ZSE 75 GL 22D units.

The LFT extrudate containing the molten resin portion was robotically transported to a low cycle time profile press for molding into a desired part profile. A non-limiting example of such profile press is commercially available Dieffenbacher Compress+[official website: www.Dieffenbacher.com], delivering about 3600/3200 ton compression force. The profiled parts were robotically transported to the downstream processing section for finished articles, for example, fabrics, sheets, plaques, and the like.

The general parameters used during DLFT processing were: 300° C. conveyor belt temperature, 80° C. mold temperature, 60 sec cooling time, 290° C. barrel temperature, about 200 RPM screw speed, polymer melt mass temperature in the 280-290° C. range.

In this example, the specimen plaques were produced via sheet molding in a way to orient the glass fiber distribution in the mold flow direction. This retained anisotropic properties in the plaques so that parallel and cross direction properties can be determined for mechanical performance.

The representative test samples were cut from these plaques to include both, the length-wise and cross-wise fiber direction. The test samples conforming to the ISO 527 and ISO 179 specifications were prepared from each of the specimen plaques.

### Ash Test to Determine Glass Fiber Content.

The LFT-processed plaque test samples underwent ash test to determine the glass fiber content. An infrared oven was used to run these tests in an air environment at 750° C. temperature for 15 minutes. Upon complete polyamide resin burn-off in 15 minutes of exposure the post-ash test materials were used to determine the glass fiber content that was distributed in the samples. Table 5 provides the ash test data confirming a uniform on-target glass fiber distribution in the polyamide matrix.

TABLE 5

| | | Specimens prepared from Table 3 | | |
|---|---|---|---|---|
| | | Compositions of . . . | | |
| | | Example 2A | Example 2B | Example 2E |
| Ash Test Results | Target | Measured | Measured | Measured |
| Glass Fiber | 30 | 30 | 28 | 27 |
| Content, wt. % | 40 | 40 | 39 | 40 |
| | 50 | 47 | 48 | 47 |

FIG. 1 represents the measured number-averaged glass fiber fraction (Y-axis) as a function of the measured glass fiber length in mm (X-axis) for the above tested samples. In FIG. 1 Legend, the term “U2501” refers to Example 2A specimens, the term “A” refers to Example 2B specimens, and the term “NPD” refers to Example 2E specimens. The terms “GF30” and “GF40” refer to 30 wt. % and 40 wt. % glass fiber content in the specimens, respectively. Table 6 below shows the measured number-averaged fiber length distribution for individual specimens prepared according to the present disclosure.

TABLE 6

| Target | | | | | | | | | |
|---|---|---|---|---|---|---|---|---|---|
| Glass Fiber | Specimens prepared from Table 3 Compositions of . . . | | | | | | | | |
| Content | Example 2A | | | Example 2B | | | Example 2E | | |
| (wt. %) | 30 | 40 | 50 | 30 | 40 | 50 | 30 | 40 | 50 |
| Fiber Length | Number-averaged Fiber Length Distribution in % of total | | | | | | | | |
| 0.5-1.0 mm | 16-17% | 17.5-25% | No | 16-18% | 17.5-26% | No | 20-34% | 26-36.5% | No |
| 1.0-2.0 mm | 7.5-16% | 7.5-20% | Data | 8.5-16% | 7.5-21% | Data | 5-20% | 5-26.5% | Data |
| 2.0-5.0 mm | 1.5-7.5% | 3-7.5% | | 2-7.5% | 2-7.5% | | 1.5-5% | 1.5-5% | |
| Cumulative | 25-41% | 28-53% | | 27-42% | 27-55% | | 27-59% | 33-68% | |
| (0.5-5.0 mm) | | | | | | | | | |

A high cumulative number-averaged distribution of the glass fiber length between 0.5-5 mm in the tested D-LFT process specimens was evident from the FIG. 1 and Table 6 data. In contrast, a conventional injection molded polyamide resin samples having similar glass fiber levels typically show the cumulative number-average distribution of 70-80% in the much shorter 0.2-0.3 mm fiber length range.

### Mechanical Performance—Impact Testing Using ISO 179 Method.

The above D-LFT molded test samples were tested for impact using the ISO 179 method. A 5-Joule force for unnotched and 1-Joule force for notched impact testing was used over an impact pendulum span of 60 mm.

### Mechanical Performance—Tensile Testing Using ISO 527 Method.

A Shimadzu AG-X Plus instrument was used with a 10 kilo-Newton (kN) load cell was used for the tensile test according to the ISO 527 Method. The crosshead speed was 1 mm/min to the extension of 0.4% and 50 mm/min to the break. The strain was measured mid-span of the test specimens using an optical extensometer Shimadzu TRViewX. The gauge length was 50 mm and the gripping distance was 115 mm.

The mechanical performance data included Tensile Strength (MPa), % Elongation at Break, Tensile Modulus (MPa), Unnotched Charpy (kJ/m²) impact strength at 23° C. according to the ISO 179/1 eU method and Notched Charpy (kJ/m²) impact strength at 23° C. according to the ISO 179/1 eA method. The performance data were collected in the length-wise direction of the test specimen (i.e., impact that was perpendicular to the glass fiber orientation in the specimen) as well as in the cross-wise direction of the test specimen (i.e., impact that was parallel to the glass fiber orientation in the specimen).

Tables 7A-C represent the mechanical performance data collected in the length-wise direction of the test specimens, and Tables 7D-F represent the mechanical performance data collected in the cross-wise direction of the test specimens. The D-LFT produced test specimens included Table 3 Examples 2A, 2B and 2E compositions containing 30 wt. %, 40 wt. % and 50 wt. % glass fiber. All conditioned or “Cond” samples were immersed in water for three days at room temperature, then dried in the 50% relative humidity (50% RH) to equilibrate. The “dry” samples contained less than 0.2 wt % moisture.

TABLE 7A

| Mechanical | For Table 3 Example 2A Composition with . . . | | | | | |
|---|---|---|---|---|---|---|
| Performance Data | 30 wt. % GF | | 40 wt. % GF | | 50 wt. % GF | |
| [Length-wise | Content | | Content | | Content | |
| direction] | Dry | Cond | Dry | Cond | Dry | Cond |
| Tensile Strength | 186 | 143 | 188 | 178 | 170 | Not |
| (MPa) | | | | | | Measured |
| Elongation @ Break | 2.9 | 4.2 | 2.7 | 4.2 | 2.7 | |
| (%) | | | | | | |
| Tensile Modulus | 9650 | 7870 | 11400 | 10330 | 11970 | |
| (MPa) | | | | | | |
| 23° C. Unnotched | 57 | 65 | 76 | 83 | 72 | |
| Charpy (kJ/m²) | | | | | | |
| 23° C. Notched | 23 | 22 | 25 | 26 | 22 | |
| Charpy (kJ/m²) | | | | | | |

TABLE 7B

| Mechanical | For Table 3 Example 2B Composition with . . . | | | | | |
|---|---|---|---|---|---|---|
| Performance Data | 30 wt. % GF | | 40 wt. % GF | | 50 wt. % GF | |
| (Length-wise | Content | | Content | | Content | |
| direction) | Dry | Cond | Dry | Cond | Dry | Cond |
| Tensile Strength | 183 | 129 | 245 | 166 | 263 | Not |
| (MPa) | | | | | | Measured |
| Elongation @ | 3.6 | 4.2 | 4.2 | 4.3 | 3.9 | |
| Break (%) | | | | | | |
| Tensile Modulus | 7769 | 7730 | 10800 | 9490 | 17700 | |
| (MPa) | | | | | | |
| 23° C. Unnotched | 46 | 77 | 68 | 100 | 78 | |
| Charpy (kJ/m²) | | | | | | |
| 23° C. Notched | 18 | 22 | 24 | 27 | 25 | |
| Charpy (kJ/m²) | | | | | | |

TABLE 7C

| Mechanical | For Table 3 Example 2E Composition with . . . | | | | | |
|---|---|---|---|---|---|---|
| Performance Data | 30 wt. % GF | | 40 wt. % GF | | 50 wt. % GF | |
| (Length-wise | Content | | Content | | Content | |
| direction) | Dry | Cond | Dry | Cond | Dry | Cond |
| Tensile Strength | 196 | 126 | 241 | 150 | 231 | Not |
| (MPa) | | | | | | Measured |
| Elongation a | 4.0 | 6.6 | 4.4 | 4.8 | 4.1 | |
| Break (%) | | | | | | |
| Tensile Modulus | 7040 | 6660 | 11580 | 8810 | 12840 | |
| (MPa) | | | | | | |
| 23° C. Unnotched | 51 | 90 | 58 | 98 | 63 | |
| Charpy (kJ/m²) | | | | | | |
| 23° C. Notched | 18 | 24 | 24 | 29 | 22 | |
| Charpy (kJ/m²) | | | | | | |

TABLE 7D

| | For Table 3 Example 2A Composition with . . . | | | | | |
|---|---|---|---|---|---|---|
| Mechanical | 30 wt. % GF | | 40 wt. % GF | | 50 wt. % GF | |
| Performance Data | Content | | Content | | Content | |
| (Cross-wise direction) | Dry | Cond | Dry | Cond | Dry | Cond |
| Tensile Strength (MPa) | 50 | 55 | 59 | 58 | 47 | Not |
| Elongation @ Break | 1.5 | 3.5 | 1.1 | 3.3 | 1.3 | Measured |
| (%) | | | | | | |
| Tensile Modulus (MPa) | 5050 | 2670 | 5800 | 3450 | 5920 | |
| 23° C. Unnotched | 12 | 42 | 14 | 55 | 13 | |
| Charpy (kJ/m²) | | | | | | |
| 23° C. Notched Charpy | 9 | 11 | 10 | 14 | 8 | |
| (kJ/m²) | | | | | | |

TABLE 7E

| Mechanical | For Table 3 Example 2B Composition with . . . | | | | | |
|---|---|---|---|---|---|---|
| Performance Data | 30 wt. % GF | | 40 wt. % GF | | 50 wt. % GF | |
| (Cross-wise | Content | | Content | | Content | |
| direction) | Dry | Cond | Dry | Cond | Dry | Cond |
| Tensile Strength | 72 | 43 | 81 | 50 | 89 | Not |
| (MPa) | | | | | | Measured |
| Elongation @ Break | 2 | 2.5 | 2 | 2.3 | 1.9 | |
| (%) | | | | | | |
| Tensile Modulus | 4590 | 2890 | 4890 | 3690 | 7630 | |
| (MPa) | | | | | | |
| 23° C. Unnotched | 11 | 35 | 14 | 45 | 12 | |
| Charpy (kJ/m²) | | | | | | |
| 23° C. Notched | 7 | 7 | 7 | 9 | 7 | |
| Charpy (kJ/m²) | | | | | | |

TABLE 7F

| Mechanical | For Table 3 Example 2E Composition with . . . | | | | | |
|---|---|---|---|---|---|---|
| Performance Data | 30 wt. % GF | | 40 wt. % GF | | 50 wt. % GF | |
| (Cross-wise | Content | | Content | | Content | |
| direction) | Dry | Cond | Dry | Cond | Dry | Cond |
| Tensile Strength | 92 | 54 | 98 | 57 | 94 | Not |
| (MPa) | | | | | | Measured |
| Elongation @ Break | 2.7 | 10.1 | 2.5 | 6.6 | 2.3 | |
| (%) | | | | | | |
| Tensile Modulus | 4170 | 1830 | 5540 | 2740 | 6390 | |
| (MPa) | | | | | | |
| 23° C. Unnotched | 17 | NB | 21 | NB | 17 | |
| Charpy (kJ/m²) | | | | | | |
| 23° C. Notched | 6 | 17 | 6 | 16 | 7 | |
| Charpy (kJ/m²) | | | | | | |

### Examples 8(a-d). Compression-Molded Parts and Articles Using the Compositions of the Present Disclosure

Using the modified polyamide compositions according to the present disclosure, molded parts and articles have a form-factor of from 2 to 5,000 m²/m³ volume-specific surface area. It is also observed that the molded parts and articles are formed without structural defects.
8(a)—In one aspect, a 16-inch diameter (and about 2-inch thick) bicycle wheel rim with about ⅔rd open area is compression-molded to yield about 40 m²/m³ volume-specific surface area and no visible structural defects.
8(b)—In another aspect, a rectangular 130-cm long×20-cm wide×1-cm deep vehicular battery hold tray is compression-molded to yield about 700 m²/m³ volume-specific surface area and no visible structural defects.
8(c)—In another aspect, a vehicular tire trunk part is compression-molded to yield the volume-specific surface area within the m²/m³ values of 9(a) and 9(b) and no visible structural defects.
8(d)—In one aspect, a closed-end, cylinder-shaped, hollow enclosure of dimensions 36-inch outside diameter×60-inch length×4-mm structural thickness is compression-molded to yield about 575 m²/m³ volume-specific surface area and no visible structural defects. Such closed-end, cylinder-shaped, hollow enclosure may be suitable to house telecommunications equipment and devices.
8(e)—In another aspect, a closed-end, rectangular-shaped, hollow enclosure of linear dimensions 48-inch×24-inch×12-inch and 2-mm structural thickness for all sides is compression-molded to yield about 1,000 m²/m³ volume-specific surface area and no visible structural defects. Such closed-end, rectangular-shaped, hollow enclosure may be suitable to house telecommunications equipment and devices.

### Examples 9(a-f). Crystallization Behavior of PA66:PA66/DI Test Specimens Via FSC Technique

Crystallization behavior of several PA66:PA66/DI test specimens, according to the present disclosure, were determined using isothermal FSC technique. The term “PA66/DI” means a copolymer of PA66 and DI, while the term “PA66:PA66/DI” is a blend between PA66 and PA66/DI copolymer.

The test specimens included were (wt:wt) 100% PA66 [INVISTA U4803 PA66], 90:10 PA66:PA66/DI, 80:20 PA66:PA66/DI, 70:30 PA66:PA66/DI, 50:50 PA66:PA66/DI, and 100% PA66/DI. It will be appreciated that the other PA66:PA66/DI (wt:wt) blend compositions would fall between these measurement series, for example, 97:3, 92:8 or 85:15 and such. The copolymer PA66/DI used in these examples was 92/8 (wt. basis) PA66/DI (or, 91.4/8.6 molar basis). The “resulting DI in total” is a non-PA66 component content in these blends.

The tested PA66:PA66/DI blends were prepared using a twin-screw extruder, a Coperion ZSK-18 twin-screw extruder. The blended specimens were run under isothermal temperatures using FSC technique and the peak crystallization time was measured at each maintained temperature ranging from 85° C. to 220° C. Typically samples were heated to 300° C. at 2000K/s, held for 0.5 s and cooled at 2000K/s to Hold temperature. A typical run series consisted of hold Temperatures from 220° C. to 85° C. at 5° C. increments, each for 10 s Hold Time. Table 8 below tabulates the isothermal FSC results for all tested samples.

TABLE 8

| | | | | | | |
|---|---|---|---|---|---|---|
| Example ID.- | 9(a) | 9(b) | 9(c) | 9(d) | 9(e) | 9(f) |

Composition [wt. %]

| | | | | | | |
|---|---|---|---|---|---|---|
| U4803 PA66 | 100 | 90 | 80 | 70 | 50 | — |
| [48 RV] | | | | | | |
| PA66/DI (91.4/8.6 | — | 10 | 20 | 30 | 50 | 100 |
| molar) [44 RV] | | | | | | |
| Resulting “DI” in | 0 | 0.86 | 1.72 | 2.58 | 4.3 | 8.6 |
| total (mole %) | | | | | | |

Crystallization Behavior by FSC Technique [Isothermal]

| Isothermal | Peak Crystallization Time observed during | | | | | |
|---|---|---|---|---|---|---|
| @ ° C. | Isothermal Crystallization [seconds] | | | | | |
| 85 | 0.92 | 1.22 | 1.59 | 2.09 | | |
| 90 | 0.60 | 0.79 | 1.03 | 1.24 | 2.07 | |
| 95 | 0.44 | 0.56 | 0.73 | 0.86 | 1.38 | 4.09 |
| 100 | 0.35 | 0.43 | 0.55 | 0.66 | 1.01 | 2.75 |
| 105 | 0.28 | 0.37 | 0.45 | 0.54 | 0.80 | 1.77 |
| 110 | 0.24 | 0.32 | 0.36 | 0.46 | 0.64 | 1.31 |
| 115 | 0.21 | 0.29 | 0.31 | 0.40 | 0.53 | 1.03 |
| 120 | 0.19 | 0.27 | 0.27 | 0.36 | 0.45 | 0.91 |
| 125 | 0.17 | 0.26 | 0.26 | 0.35 | 0.42 | 0.83 |
| 130 | 0.17 | 0.28 | 0.26 | 0.36 | 0.42 | 0.87 |
| 135 | 0.18 | 0.32 | 0.29 | 0.39 | 0.45 | 0.93 |
| 140 | 0.19 | 0.39 | 0.34 | 0.45 | 0.52 | 1.17 |
| 145 | 0.20 | 0.39 | 0.38 | 0.48 | 0.57 | 1.31 |
| 150 | 0.20 | | 0.40 | 0.46 | 0.63 | 1.44 |
| 155 | 0.19 | | 0.40 | 0.42 | 0.60 | 1.35 |
| 160 | 0.18 | | 0.38 | 0.38 | 0.55 | 1.34 |
| 165 | 0.19 | | 0.38 | 0.38 | 0.57 | 1.32 |
| 170 | 0.19 | | 0.38 | 0.38 | 0.53 | 1.30 |
| 175 | 0.20 | | 0.38 | 0.41 | 0.57 | 1.38 |
| 180 | 0.22 | | 0.40 | 0.46 | 0.59 | 1.45 |
| 185 | 0.25 | | 0.45 | 0.52 | 0.63 | 1.69 |
| 190 | 0.29 | | 0.51 | 0.59 | 0.74 | 2.17 |
| 195 | 0.35 | | 0.64 | 0.72 | 0.81 | 2.46 |
| 200 | 0.44 | | 0.82 | 0.88 | 0.98 | |
| 205 | 0.58 | 0.42 | 1.00 | 1.03 | 1.17 | |
| 210 | 0.85 | 0.74 | 1.39 | 1.08 | 1.52 | |
| 215 | 1.29 | 1.16 | 2.08 | 1.93 | 1.92 | |
| 220 | 1.89 | 2.36 | 2.98 | 1.94 | | |

Not measured for Example 9b—(90:10 66:66/DI) blend for 150-200° C. range.

It was observed that the time (in seconds) to peak crystallization increased as the “DI” component portion increased in the tested PA66:PA66/DI specimens (see Table 8 column values going from left-to-right at each temperature point). 4,7

In the temperature range of 85° C. to 220° C., the slow-down factor [F_{slowdown}] in time to peak crystallization for Examples 9(b-f) with reference to Example 9(a) can be approximated as:

F_{slowdown}˜1.0+A×[M]+B×[M]
wherein,
   F_{slowdown}=[time_{to peak crystallization for PA66:PA66/DI blend}]/[time_{to peak crystallization for neat PA66}]
   [M]=mole % of “DI” portion present in PA66:PA66/DI resin;
   A=1^{st} coefficient, ranges from
      0.25≤A≤0.32 for 85-140° C. temperature range,
      −0.2≤A≤0.45 for 140-220° C. temperature range;
         and
B=2^{nd} coefficient, ranges from
   0.02≤B≤0.07 for 85-140° C. temperature range,
   0.04≤B≤0.09 for 140-220° C. temperature range.

It is understood that the slow-down factor is unity (1.0) when [M]=0 (i.e., neat PA66 containing no “DI” portion).

As for illustration, the peak crystallization slow-down factor, F_{slowdown}, for a 65:35 (wt:wt) PA66:PA66/DI resin (having 91.4:8.6 molar 66:DI) operating in the 140-220° C. temperature range can be approximated to be from about 1.2 (minimum) to about 2.7 (maximum) with an average of about 2.1. In this illustration, the values used are: [M]=3.0, A=(−0.2) min/(0.2) avg/(0.45) max, and B=(0.09) min/(0.06) avg/(0.04) max.

In another illustration, the peak crystallization slow-down factor, F_{slowdown}, for a 85:15 (wt:wt) PA66:PA66/DI resin (having 91.4:8.6 molar 66:DI) operating in the 85-140° C. temperature range can be approximated to be from about 1.36 (minimum) to about 1.53 (maximum) with an average of about 1.44. In this illustration, the values used are: [M]=1.3, A=(0.25) min/(0.3) avg/(0.32) max, and B=(0.02) min/(0.034) avg/(0.07) max.

### Examples 10(a-h): Crystallization Behavior of PA66:PA6I/6T Test Specimens Via FSC Technique

Crystallization behavior of several PA66:PA6I/6T test specimens, according to the present disclosure, were determined using isothermal FSC technique. The term “PA6I/6T” means a copolymer of PA6I and PA6T, while the term “PA66:PA6I/6T” is a blend between PA66 and PA6I/6T copolymer. The “resulting I+T in total” is a non-PA66 component content in these blends.

The test specimens included were (wt:wt) 100% PA66 (INVISTA U4803 PA66), 95:5 PA66:PA6I/6T, 90:10 PA66:PA6I/6T, 80:20 PA66:PA6I/6T, and 70:30 PA66:PA6I/6T. Two commercially available varieties of PA6I/6T were used in these examples, namely, EMS-Grivory Grivory® G16 and Grivory® G21 nylon copolymers.

The tested PA66:PA6I/6T blends were prepared using a twin-screw extruder, a Coperion ZSK18. The blended specimens were run under isothermal temperatures using FSC technique and the peak crystallization time was measured at each maintained temperature ranging from 85° C. to 220° C.

Table 9 below tabulates the isothermal FSC results for all tested samples.

TABLE 9

| | | | | | | | | |
|---|---|---|---|---|---|---|---|---|
| Example ID.- | 10(a) | 10(b) | 10(c) | 10(d) | 10(e) | 10(f) | 10(g) | 10(h) |

Composition [wt. %]

| U4803 PA66 | 100 | 95 | 90 | 90 | 80 | 80 | 70 | 70 |
|---|---|---|---|---|---|---|---|---|
| [48 RV] | | | | | | | | |
| PA6I/6T | | | | | | | | |
| EMS-Grivory ® | — | 5 | 10 | — | 20 | — | 30 | — |
| G16 | | | | | | | | |
| EMS-Grivory ® | — | — | — | 10 | — | 20 | — | 30 |
| G21 | | | | | | | | |
| Resulting I + T in | 0 | 2.7 | 5.4 | | 10.7 | | 16.1 | |
| total (mole %) | | | | | | | | |

Crystallization Behavior by FSC Technique [Isothermal]

| Isothermal | Peak Crystallization Time observed during Isothermal | | | | | | | |
|---|---|---|---|---|---|---|---|---|
| @ ° C. | Crystallization [seconds] | | | | | | | |
| 85 | 0.92 | | 4.23 | 4.60 | | | | |
| 90 | 0.60 | 1.26 | 2.80 | 2.97 | | | | |
| 95 | 0.44 | 0.86 | 1.83 | 2.03 | | | | |
| 100 | 0.35 | 0.64 | 1.34 | 1.36 | | | | |
| 105 | 0.28 | 0.53 | 1.05 | 1.09 | 3.03 | 3.81 | | |
| 110 | 0.24 | 0.47 | 0.87 | 0.95 | 2.08 | 3.19 | | |
| 115 | 0.21 | 0.43 | 0.74 | 0.87 | 1.45 | 2.83 | 4.74 | |
| 120 | 0.19 | 0.41 | 0.64 | 0.86 | 1.10 | 2.58 | 3.32 | |
| 125 | 0.17 | 0.40 | 0.58 | 0.88 | 0.94 | 2.44 | 2.59 | 7.41 |
| 130 | 0.17 | 0.40 | 0.55 | 0.91 | 0.87 | 2.27 | 2.19 | 6.66 |
| 135 | 0.18 | 0.40 | 0.52 | 0.87 | 0.86 | 1.98 | 2.04 | 6.07 |
| 140 | 0.19 | 0.39 | 0.49 | 0.76 | 0.90 | 1.89 | 2.00 | 5.47 |
| 145 | 0.20 | 0.35 | 0.43 | 0.64 | 1.00 | 1.57 | 2.11 | 4.73 |
| 150 | 0.20 | 0.31 | 0.38 | 0.56 | 1.15 | 1.41 | 2.37 | 3.94 |
| 155 | 0.19 | 0.28 | 0.34 | 0.50 | 1.26 | 1.21 | 2.70 | 3.22 |
| 160 | 0.18 | 0.26 | 0.32 | 0.47 | 1.22 | 1.12 | 2.96 | 2.94 |
| 165 | 0.19 | 0.25 | 0.30 | 0.45 | 1.18 | 1.09 | 2.99 | 2.62 |
| 170 | 0.19 | 0.24 | 0.30 | 0.45 | 1.14 | 1.07 | 2.89 | 2.48 |
| 175 | 0.20 | 0.26 | 0.31 | 0.45 | 1.09 | 1.08 | 2.78 | 2.54 |
| 180 | 0.22 | 0.28 | 0.32 | 0.47 | 1.13 | 1.13 | 2.73 | 2.56 |
| 185 | 0.25 | 0.31 | 0.34 | 0.50 | 1.19 | 1.22 | 2.79 | 2.68 |
| 190 | 0.29 | 0.35 | 0.37 | 0.54 | 1.27 | 1.34 | 2.88 | 2.97 |
| 195 | 0.35 | 0.41 | 0.42 | 0.60 | 1.35 | 1.52 | 3.18 | 3.15 |
| 200 | 0.44 | 0.53 | 0.49 | 0.68 | 1.49 | 1.74 | 3.49 | 3.77 |
| 205 | 0.58 | 0.62 | 0.60 | 0.78 | 1.53 | 1.93 | 3.44 | 3.54 |
| 210 | 0.85 | 0.85 | 0.72 | 0.93 | 1.66 | 2.20 | 3.87 | 4.29 |
| 215 | 1.29 | 1.16 | 0.89 | 1.15 | 1.81 | 2.36 | | 4.45 |
| 220 | 1.89 | 1.89 | 1.21 | 1.48 | 2.27 | 2.45 | | 4.58 |

In general, it was observed that the time [in seconds] to peak crystallization increased as the “I+T” portion increased in the tested PA66:PA6I/6T specimens [see Table 9 column values going from left-to-right at each temperature point].

In the temperature range of 85° C. to 220° C., the slow-down factor (F′_{slowdown}) in time to peak crystallization for the EMS-Grivory® G16 containing specimens in Examples 10(b), 10(c), 10(e) and 10(g) with reference to Example 10(a) can be approximated as:

F′_{slowdown}˜1.0+A′×[M′]+B′×[M′]²
wherein,
   F′_{slowdown}=[time_{to peak crystallization for PA66:PA6I/6T blend}]/[time_{to peak crystallization for neat PA66}]
   [M′]=mole % of “I+T” portion present in the PA66:PA6I/6T resin;
   A′=1^{st} coefficient, ranges from
      0.06≤A′≤0.2 for 85-140° C. temperature range,
      −0.25≤A′≤−0.08 for 140-220° C. temperature range; and
   B′=2^{nd} coefficient, ranges from
      0.03≤B′≤0.07 for 85-140° C. temperature range,
      0.03≤B′≤0.06 for 140-220° C. temperature range.

It is understood that the slow-down factor is unity (1.0) when [M′]=0 (i.e., neat PA66 containing no “I+T” portion).

As for illustration, the peak crystallization slow-down factor, F′_{slowdown}, for a 75:25 (wt:wt) PA66:PA6I/6T resin operating in the 140-220° C. temperature range can be approximated to be from about 3.0 (minimum) to about 11 (maximum) with an average of about 7. In this illustration, the values used are: [M′]=13.4, A′=(−0.25) min/(−0.21) avg/(−0.08) max, and B′=(0.03) min/(0.05) avg/(0.06) max.

In another illustration, the peak crystallization slow-down factor, F′_{slowdown}, for a 92:8 (wt:wt) PA66:PA6I/6T resin operating in the 85-140° C. temperature range can be approximated to be from about 1.8 (minimum) to about 3.1 (maximum) with an average of about 2.3. In this illustration, the values used are: [M′]=4.3, A′=(0.06) min/(0.12) avg/(0.2) max, and B′=(0.03) min/(0.05) avg/(0.07) max.

### Examples 11(a-d): Compositions with Improved Flame Retardancy

Table 10 below shows several compoundable thermoplastic resin compositions prepared using a twin screw extruder, a Coperion ZSK18, that contain flame retardant additive (Exolit® OP 1314, commercially available from Clariant Plastics and Coatings (Deutschland) GmbH) and traditional short glass fiber reinforcement (NEG HP3610 chopped glass fiber, commercially available from Nippon Electric Glass Co., Ltd.) and an antioxidant (Irganox® B1171, commercially available from BTC Europe GmbH). The compounded products were injection molded into Flammability bars of specified thicknesses and their vertical flammability rating determined following the procedure of ASTM D3801.

TABLE 10

| | Example ID: | | | |
|---|---|---|---|---|
| | 11(a) | | | |
| | Comparative | 11(b) | 11(c) | 11(d) |
| Component (wt. %) | | | | |
| PA66 (35 RV) | 57.2 | — | — | — |
| PA66 (25 RV) | — | — | — | 28.6 |
| PA66/DI (92/8 | — | 57.2 | — | 28.6 |
| w/w) (RV 44) | | | | |
| PA66/DI (92/8 | — | — | 57.2 | — |
| w/w) (RV 35) | | | | |
| Irganox ® B1171 | 0.2 | 0.2 | 0.2 | 0.2 |
| (antioxidant) | | | | |
| Exolit ® OP 1314 | 12.6 | 12.6 | 12.6 | 12.6 |
| (FR additive) | | | | |
| NEG HP3160 | 30 | 30 | 30 | 30 |
| (chopped Glass Fiber) | | | | |

ASTM D3801 Rating @ specimen bar thickness

| | | | | |
|---|---|---|---|---|
| 0.40 mm | V-Fail | V-Fail | V-Fail | V-Fail |
| 0.71 mm | V-Fail | V-1 | V-1 | V-2 |
| 1.50 mm | V-1 | V-0 | V-1 | V-1 |
| 3.0 mm | V-0 | V-0 | V-0 | V-0 |

At the 12.6 wt. % Exolit® OP 1314 level and 30 wt. % chopped glass fiber, all samples including the Comparative Example 11(a) obtained the rating of V-Fail at 0.40 mm and V-0 at 3.0 mm Flammability bar thicknesses. At 0.71 mm Flammability bars thickness samples in Examples 11(b), (c) and (d) achieved better Flammability rating than the Comparative Example 11(a). At 1.5 mm Flammability bar thickness sample 11(b) achieved better Flammability rating than the Comparative Example 11(a). These examples serve to illustrate the flammability improvement that may be achieved in a polyamide composition including a polyamide or random copolymer including DI and a flame retardant additive according to the present disclosure.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of the present invention.

### Exemplary Aspects

The following exemplary Aspects are provided, the numbering of which is not to be construed as designating levels of importance:

Aspect 1 provides a compounded thermoplastic resin comprising:
a) from ≥20 to ≤99 wt. % of a polyamide composition comprising a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent);
b) up to ≤70 wt. % of a random copolymer composition;
c) up to 50 wt. % of a co-polyamide of hexamethylene isophthalamide and hexamethylene terephthalamide (PA6I/6T); and optionally
d) up to 60 wt. % of a non-polyhexamethylene adipamide (non-PA66) component;
   wherein, the compounded thermoplastic resin is characterized by Melt Flow Index (MFI) of 10 to 80, melt temperature range of 245-265° C., and crystallization temp range of 195-220° C.;
wherein the MFI is measured according to ISO Method 1133 for 0.325 kg sample weight having between 0.13 wt. % to 0.20 wt. % moisture at 275° C. test temperature; and wherein all wt. % values in parts a)-d) are based on the total mass of the compounded thermoplastic resin.

Aspect 2 provides the compounded thermoplastic resin of Aspect 1, wherein the polyamide composition a) has the amine end group (AEG) value in the range of ≥30 to ≤130 milliequivalents/kg (meq/kg).

Aspect 3 provides the compounded thermoplastic resin of any one of Aspects 1-2, wherein the polyamide composition a) is polyhexamethylene adipamide (PA66).

Aspect 4 provides the compounded thermoplastic resin of any one of Aspects 1-3, wherein the random copolymer composition b) comprises at least one selected from:
i) a copolymer of polyhexamethylene adipamide (PA66) and poly-2-methylpentamethylene isophthalamide (DI), wherein the mass ratio of copolymer (PA66/DI) is from 80:20 to 97:3,
ii) a copolymer of polyhexamethylene adipamide (PA66) and poly-2-methylpentamethylene adipamide (D6), wherein the mass ratio of copolymer (PA66/D6) is from 70:30 to 90:10,
iii) a copolymer of polyhexamethylene adipamide (PA66) and polyhexamethylene terephthalamide (6T), wherein the mass ratio of copolymer (PA66:6T) is from 75:25 to 55:45,
iv) a copolymer of poly-2-methylpentamethylene terephthalamide (DT) and poly-2-methylpentamethylene isophthalamide (DI); wherein the mass ratio of copolymer (DT/DI) is from 60:40 to 40:60,
v) syndiotactic polystyrene (SPS),
vi) styrene-maleic anhydride (SMA) and
vii) imidized styrene-maleic anhydride (SMI).

Aspect 5 provides the compounded thermoplastic resin of any one of Aspects 1-4, wherein the non-polyhexamethylene adipamide (non-PA66) component d) comprises at least one selected from polycaproamide (PA6), polyheptanamide (PA7), polynonanamide (PA9), polyhexamethylene decanamide (PA610), polyhexamethylene dodecanamide (PA612), polytetramethylene adipamide (PA46), polytetramethylene sebacamide (PA410), polypentamethylene adipamide (PA56), polyhexamethylene azelamide (PA69), polypentamethylene sebacamide (PA510), polydecamethylene sebacamide (PA1010), polydecamethylene dodecanamide (PA1012), polypentamethylene dodecanamide (PA512), polydodecamethylene dodecanamide (PA1212), polyundecanamide (PA 11), polylaurolactam (PA12) and copolymer of poly-hexamethylene terephthalamide and poly-2-methylpentamethylene terephthalamide (PA6T/DT).

Aspect 6 provides the compounded thermoplastic resin of any one of Aspects 1-5, further comprising ≥0.1 to ≤2 wt. % heat stabilizer based on the total mass of the resin.

Aspect 7 provides the compounded thermoplastic resin of any one of Aspects 1-6 where the polyamide composition comprises any of the copolymers of materials i) to iii) in Aspect 4.

Aspect 8 provides a method of making a compounded thermoplastic resin, the method comprising:
a) feeding a polyamide, a random copolymer, a co-polyamide of hexamethylene isophthalamide and hexamethylene terephthalamide, and a heat stabilizer.
b) maintaining conditions in the compounding zone to blend the contents to form a homogeneous compounded thermoplastic resin melt;
c) recovering the compounded thermoplastic resin melt from step b), and
d) producing extrudate from step c)'s compounded thermoplastic resin melt;
wherein, the compounded thermoplastic resin is characterized by Melt Flow Index (MFI) of 10 to 80; the MFI is measured according to ISO Method 1133 for 0.325 kg sample weight having between 0.13 wt. % to 0.20 wt. % moisture at 275° C. test temperature.

Aspect 9 provides a molded article prepared from the compounded thermoplastic resin of any one of Aspects 1 to 7, wherein, the article is substantially free of reinforcing fiber, or the article is a molded article that comprises reinforcing fiber.

Aspect 10 provides the molded article of Aspect 9 comprising ≥10 wt % to ≤60 wt % reinforcing fiber, based on the total weight of the article.

Aspect 11 provides the molded article of any one of Aspects 9-10 wherein, the reinforcing fiber is selected from the group consisting of carbon fiber, carbon nano-fiber, short glass fiber, long glass fiber, basalt fiber, natural fiber, mineral fiber, nano-cellulosic fiber, wood fibers, non-wood plant fibers and combinations thereof.

Aspect 12 provides the molded article of any one of Aspects 9-11 wherein, the reinforcing fiber is a glass fiber.

Aspect 13 provides the molded article of any one of Aspects 12 comprising the glass fiber, based on the total weight of the article, is selected from:
≥10 wt. % to ≤60 wt. %,
≥20 wt. % to ≤55 wt. %, and
≥25 wt. % to ≤50 wt. %.

Aspect 14 provides the molded article of any one of Aspects 12-13 wherein, the cumulative number-averaged distribution of the glass fiber in the 0.5-5 mm linear length is ≥20% to ≤70% by weight, based on the total weight of the article.

Aspect 15 provides a molding composition comprising:
first component comprising PA66 polyamide having RV from ≥20 to ≤50 measured at room temperature and pressure (RV determined from a 8.4 wt % polyamide solution in 90% formic acid and RV is the ratio of the viscosity of the polyamide solution to the viscosity of the solvent);
second component comprising glass fibers where the cumulative number-averaged distribution of the glass fiber in the 0.5-5 mm linear length is ≥20% to ≤70% by weight, based upon total weight of glass fibers in the molding composition; and
third component selected from at least partially aromatic polyamides and at least partially branched aliphatic polyamides, the third component present in the molding composition at concentration sufficient to suppress molding fractures when a Direct Long Fiber Thermoplastic (DLFT) molding preform is pressed into a DLFT mold at temperature of from 240° C. to 265° C.

Aspect 16 provides the molding composition of Aspect 15 wherein the second component is present as ≥10 wt. % to ≤60 wt. % of the molding composition.

Aspect 17 provides the molding composition of any one of Aspects 15-16, wherein the third component is present in the molding composition at concentration sufficient to suppressing molding fractures when a DLFT molding preform of dimensions 5×5×5 cm³ is pressed into a DLFT mold of dimensions 1 cm×11.18 cm×11.18 cm at molding composition temperature of 250° C.

Aspect 18 provides the molding composition of any one of Aspects 15-17 wherein the third component is present as ≥5 wt. % to ≤70 wt. % of the molding composition.

Aspect 19 provides the molding composition of any one of Aspects 15-18 wherein the third component comprises from ≥1 wt. % to ≤30 wt. % of one or more at least partially branched aliphatic polyamides, wherein the wt. % is based on the total weight of the third component.

Aspect 20 provides the molding composition of any one of Aspects 15-19 wherein the third component comprises from ≥1 wt. % to ≤100 wt. % of one or more at least partially aromatic polyamides, wherein the wt. % is based on the total weight of the third component.

Aspect 21 provides the molding composition of any one of Aspects 15-20 wherein the third component is present at concentration sufficient such that when then DLFT molding preform is pressed into a DLFT mold to produce an article having a form factor of from 2 to 5,000 m²/m³ specific surface area, the article is formed without structural defects (as defined herein) when the second component is present at concentration from ≥10 wt. % to ≤60 wt. %, based on the total weight of the molded composition.

Aspect 22 provides the molding composition of any one of Aspects 15-21 wherein the weight ratio of the second component to the third component in the molding composition is from ≥0.1 to ≤15.

Aspect 23 provides an article comprising the molding composition of any one of Aspects 15-22.

Aspect 24 provides the article of Aspect 23 selected from: vehicular battery housing or tray;
impeller;
vehicular tire trunk or tire compartment;
enclosure; and
circular wheel rim.

Aspect 25 provides a molding composition comprising:
first component comprising PA66 polyamide having RV from ≥20 to ≤50 measured at room temperature and pressure (RV determined from a 8.4 wt % polyamide solution in 90% formic acid and RV is the ratio of the viscosity of the polyamide solution to the viscosity of the solvent);
second component comprising short glass fibers; and
third component selected from at least partially aromatic polyamides and at least partially branched aliphatic polyamides, the third component present in the molding composition at concentration sufficient to suppress molding fractures.

Aspect 26 provides the molding composition of Aspect 25 wherein the second component is present as ≥10 wt. % to ≤60 wt. % of the molding composition.

Aspect 27 provides the molding composition of any one of Aspects 25-26 wherein the third component is present as ≥5 wt. % to ≤70 wt. % of the molding composition.

Aspect 28 provides an article comprising the molding composition of any one of Aspects 25-27.

Aspect 29 provides the article of Aspect 28 selected from: vehicular radiator component;
vehicular duct;
vehicular tank;
electrical connector box;
electrical junction box; and
electronics hardware.

Aspect 30 provides a compounded thermoplastic resin comprising:
from ≥20 to ≤99 wt. %, based on the total mass of the compounded thermoplastic resin, of a polyamide composition comprising a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent);
from ≥1 wt. % to ≤70 wt. %, based on the total mass of the compounded thermoplastic resin, of a copolymer of polyhexamethylene adipamide (PA66) and poly-2-methylpentamethylene isophthalamide (DI), wherein the mass ratio of copolymer (PA66/DI) is from 80:20 to 97:3; and optionally
up to 60 wt. %, based on the total mass of the compounded thermoplastic resin, of a non-polyhexamethylene adipamide (non-PA66) component;
wherein, the time to peak crystallization of the compounded thermoplastic resin relative to that of polyhexamethylene adipamide (PA66) slows down by a factor of ≥1.1 and ≤25 in the 140° C. to 220° C. temperature range, wherein the time to peak crystallization is determined using isothermal Fast Scanning Calorimetry (FSC) technique.

Aspect 31 provides the compounded thermoplastic resin of Aspect 30, wherein the polyamide composition comprising the polyamide having RV of from ≥20 to ≤50 has an amine end group (AEG) value in the range of ≥30 to ≤130 milliequivalents/kg (meq/kg).

Aspect 32 provides the compounded thermoplastic resin of any one of Aspects 30-31, wherein the polyamide composition comprising the polyamide having RV of from ≥20 to ≤50 is polyhexamethylene adipamide (PA66).

Aspect 33 provides a compounded thermoplastic resin comprising:
from ≥20 to ≤99 wt. %, based on the total mass of the compounded thermoplastic resin, of a polyamide composition comprising a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent);
from ≥1 wt. % to ≤50 wt. %, based on the total mass of the compounded thermoplastic resin, of a co-polyamide of hexamethylene isophthalamide and hexamethylene terephthalamide (PA6I/6T); and
optionally, up to 60 wt. %, based on the total mass of the compounded thermoplastic resin, of a non-polyhexamethylene adipamide (non-PA66) component;
wherein, the time to peak crystallization of the compounded thermoplastic resin relative to that of polyhexamethylene adipamide (PA66) slows down by a factor of ≥1.1 and ≤50 in the 140° C. to 220° C. temperature range, and wherein the time to peak crystallization is determined using isothermal Fast Scanning Calorimetry (FSC) technique.

Aspect 34 provides the compounded thermoplastic resin of any one of Aspects 30-33, wherein the polyamide composition comprising a polyamide having a relative viscosity (RV) of from ≥20 to ≤50 has the amine end group (AEG) value in the range of ≥30 to ≤130 milliequivalents/kg (meq/kg).

Aspect 35 provides the compounded thermoplastic resin of any one of Aspects 30-34, wherein polyamide composition comprising the polyamide having a relative viscosity (RV) of from ≥20 to ≤50 is polyhexamethylene adipamide (PA66).

Aspect 36 provides a compounded polyamide composition comprising:
PA66 or PA66/D6 or PA66/DI that is ≥20 to ≤99 wt % of the compounded polyamide composition; and
a polymer additive that is up to ≤70 wt % of the compounded polyamide composition, the polymer additive comprising
   a polyamide copolymer,
   a polymer comprising a repeating unit comprising a styrene reaction product,
   a polyamide formable via ring-opening polymerization,
   a polyamide comprising a repeating unit comprising a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6, or
   a combination thereof.

Aspect 37 provides the compounded polyamide composition of Aspect 36, wherein the PA66 or PA66/D6 or PA66/DI is 25 wt % to 85 wt % of the compounded polyamide composition.

Aspect 38 provides the compounded polyamide composition of any one of Aspects 36-37, wherein the PA66 or PA66/D6 or PA66/DI has an RV of 15-50.

Aspect 39 provides the compounded polyamide composition of any one of Aspects 36-38, wherein the PA66 or PA66/D6 or PA66/DI has an RV of 20-45.

Aspect 40 provides the compounded polyamide composition of any one of Aspects 36-39, wherein the PA66 or PA66/D6 or PA66/DI has an RV of 20-50.

Aspect 41 provides the compounded polyamide composition of any one of Aspects 36-40, wherein the PA66 or PA66/D6 or PA66/DI has an amine end group concentration of 30 meq/kg to 130 meq/kg.

Aspect 42 provides the compounded polyamide composition of any one of Aspects 36-41, wherein the PA66 or PA66/D6 or PA66/DI has an amine end group concentration of 30 meq/kg to ≤70 meq/kg.

Aspect 43 provides the compounded polyamide composition of any one of Aspects 36-42, wherein the PA66 or PA66/D6 or PA66/DI has an amine end group concentration of 65 meq/kg to 130 meq/kg.

Aspect 44 provides the compounded polyamide composition of any one of Aspects 36-43, wherein the PA66 or PA66/D6 or PA66/DI has an amine end group concentration of 70 meq/kg to 125 meq/kg.

Aspect 45 provides the compounded polyamide composition of any one of Aspects 36-44, wherein the polymer additive is 5 wt % to 70 wt % of the compounded polyamide composition.

Aspect 46 provides the compounded polyamide composition of any one of Aspects 36-45, wherein the polymer additive is 15 wt % to 70 wt % of the compounded polyamide composition.

Aspect 47 provides the compounded polyamide composition of any one of Aspects 36-46, wherein the polyamide copolymer comprises a branched aliphatic condensation polyamide, a partially aromatic condensation polyamide, or a combination thereof.

Aspect 48 provides the compounded polyamide composition of Aspect 47, wherein the branched aliphatic condensation polyamide comprises PA66/D6, PA66/DI, or a combination thereof.

Aspect 49 provides the compounded polyamide composition of any one of Aspects 47-48, wherein the branched aliphatic condensation polyamide comprises PA66/DI.

Aspect 50 provides the compounded polyamide composition of Aspect 49, wherein the PA66/DI is 30 wt % to 70 wt % of the compounded polyamide composition.

Aspect 51 provides the compounded polyamide composition of Aspect 49, wherein the PA66/DI is 50 wt % to 70 wt % of the compounded polyamide composition.

Aspect 52 provides the compounded polyamide composition of any one of Aspects 49-51, wherein the PA66/DI is 80 wt % to 99 wt % PA66 and 1 wt % to 20 wt % DI.

Aspect 53 provides the compounded polyamide composition of Aspect 49-51, wherein the PA66/DI is 90 wt % to 95 wt % PA66 and 5 wt % to 10 wt % DI.

Aspect 54 provides the compounded polyamide composition of any one of Aspects 49-53, wherein the PA66/DI has an RV of 35 to 60.

Aspect 55 provides the compounded polyamide composition of any one of Aspects 49-53, wherein the PA66/DI has an RV of 40 to 50.

Aspect 56 provides the compounded polyamide composition of any one of Aspects 49-55, wherein the PA66/DI has an amine end group concentration of 40 meq/kg to 80 meq/kg.

Aspect 57 provides the compounded polyamide composition of any one of Aspects 49-55, wherein the PA66/DI has an amine end group concentration of 60 meq/kg to 80 meq/kg.

Aspect 58 provides the compounded polyamide composition of Aspect 49, wherein the partially aromatic condensation polyamide comprises PA66/6T, PA6I/6T, PADT/DI, or a combination thereof.

Aspect 59 provides the compounded polyamide composition of Aspect 49, wherein the partially aromatic condensation polyamide comprises PA6I/6T.

Aspect 60 provides the compounded polyamide composition of Aspect 59, wherein the PA6I/6T is 5 wt % to 40 wt % of the compounded polyamide composition.

Aspect 61 provides the compounded polyamide composition of Aspect 59, wherein the PA6I/6T is 15 wt % to 30 wt % of the compounded polyamide composition.

Aspect 62 provides the compounded polyamide composition of any one of Aspects 59-61, wherein the PA6I/6T is 1 wt % to 99 wt % PA6I and 1 wt % to 99 wt % 6T.

Aspect 63 provides the compounded polyamide composition of any one of Aspects 59-61, wherein the PA6I/6T is 20 wt % to 80 wt % PA6I and 20 wt % to 80 wt % 6T.

Aspect 64 provides the compounded polyamide composition of any one of Aspects 36-63, wherein the polyamide formable via ring-opening polymerization comprises PA6.

Aspect 65 provides the compounded polyamide composition of Aspect 64, wherein the PA6 is 5 wt % to 60 wt % of the compounded polyamide composition.

Aspect 66 provides the compounded polyamide composition of any one of Aspects 64-65, wherein the PA6 is 20 wt % to 50 wt % of the compounded polyamide composition.

Aspect 67 provides the compounded polyamide composition of any one of Aspects 36-66, wherein the polyamide comprising a repeating unit comprising a reaction product of H₂N—(CH₂)ₓ—NH₂ and HOC(O)—(CH₂)_{y}—C(O)OH comprises a homopolymer.

Aspect 68 provides the compounded polyamide composition of any one of Aspects 36-66, wherein the polyamide comprising a repeating unit comprising a reaction product of H₂N—(CH₂)ₓ—NH₂ and HOC(O)—(CH₂)_{y}—C(O)OH comprises PA610, PA612, or a combination thereof.

Aspect 69 provides the compounded polyamide composition of any one of Aspects 36-68, wherein the polymer comprising a repeating unit comprising a styrene reaction product comprises syndiotactic polystyrene (SPS).

Aspect 70 provides the compounded polyamide composition of any one of Aspects 36-69, wherein the polymer comprising a repeating unit comprising a styrene reaction product comprises imidized styrene-maleic anhydride copolymer (SMI).

Aspect 71 provides the compounded polyamide composition of any one of Aspects 36-70, wherein the polymer comprising a repeating unit comprising a styrene reaction product comprises styrene-maleic anhydride (SMA).

Aspect 72 provides the compounded polyamide composition of any one of Aspects 36-71, wherein the polymer additive comprises: a branched aliphatic condensation polyamide;
a partially aromatic condensation polyamide;
syndiotactic polystyrene (SPS);
imidized styrene-maleic anhydride copolymer (SMI);
PA6;
PA610;
PA612; or
a combination thereof.

Aspect 73 provides the compounded polyamide composition of any one of Aspects 36-72, wherein the polymer additive comprises:
PA6I/6T;
PA66/DI;
PA6; or
a combination thereof.

Aspect 74 provides the compounded polyamide composition of any one of Aspects 36-73, further comprising a heat stabilizer.

Aspect 75 provides the compounded polyamide composition of Aspect 74, wherein the heat stabilizer is 0.1 wt % to 2 wt % of the compounded polyamide composition.

Aspect 76 provides the compounded polyamide composition of Aspect 75, wherein the heat stabilizer is 0.1 wt % to 1.6 wt % of the compounded polyamide composition.

Aspect 77 provides the compounded polyamide composition of any one of Aspects 36-76, wherein the compounded polyamide composition has a melt flow index (MFI) of 10 to 36 wherein the MFI is measured according to method ISO METHOD 1133 for 0.325 kg sample weight having between 0.13 wt. % to 0.20 wt. % moisture at 275° C. test temperature.

Aspect 78 provides the compounded polyamide composition of any one of Aspects 36-77, wherein the compounded polyamide composition has a melt flow index (MFI) of 12 to 30 wherein the MFI is measured according to method ISO METHOD 1133 for 0.325 kg sample weight having between 0.13 wt. % to 20 wt. % moisture at 275° C. test temperature.

Aspect 80 provides the compounded polyamide composition of any one of Aspects 77-78, wherein the compounded polyamide composition has a melt flow index (MFI) of 12 to 25 wherein the MFI is measured according to method ISO METHOD 1133 for 0.325 kg sample weight having between 0.13 wt. % to 0.20 wt. % moisture at 275° C. test temperature.

Aspect 81 provides the compounded polyamide composition of any one of Aspects 36-80, wherein the compounded polyamide composition has a melt temperature of 230° C. to 260° C.

Aspect 82 provides the compounded polyamide composition of any one of Aspects 36-81, wherein the compounded polyamide composition has a melt temperature of 240° C. to 260° C.

Aspect 83 provides the compounded polyamide composition of any one of Aspects 36-82, wherein the compounded polyamide composition has a melt temperature of 253° C. to 259° C.

Aspect 84 provides the compounded polyamide composition of any one of Aspects 36-83, wherein the compounded polyamide composition has a crystallization temperature of 175° C. to 215° C.

Aspect 85 provides the compounded polyamide composition of any one of Aspects 36-84, wherein the compounded polyamide composition has a crystallization temperature of 185° C. to 210° C.

Aspect 86 provides the compounded polyamide composition of any one of Aspects 36-85, wherein the compounded polyamide composition has a crystallization temperature of 190° C. to 210° C.

Aspect 87 provides the compounded polyamide composition of any one of Aspects 36-86, wherein other than the PA66 or PA66/D6 or PA66/DI and the polymer additive, the compounded polyamide composition is free of polyamides.

Aspect 88 provides the compounded polyamide composition of any one of Aspects 36-87, wherein the compounded polyamide composition is free of:
novoloc resins,
reaction products of a polyhydric alcohol with a polyamide,
polyesters,
thermoplastic polyesters, or
a combination thereof.

Aspect 89 provides a compounded polyamide composition comprising:
PA66 or PA66/D6 or PA66/DI that is 25 wt % to 85 wt % of the compounded polyamide composition; and
a polymer additive that is 5 wt % to 70 wt % of the compounded polyamide composition, the polymer additive comprising
   PA66/DI,
   PA66/D6
   PA6I/6T,
   PA6, or
   a combination thereof.

Aspect 90 provides a fiber-compounded polyamide composition comprising:
the compounded polyamide composition of any one of any one of Aspects 36-89; and
a reinforcing fiber.

Aspect 91 provides the fiber-compounded polyamide composition of Aspect 90, wherein the reinforcing fiber is 10 wt % to 60 wt % of the fiber-compounded polyamide composition.

Aspect 92 provides the fiber-compounded polyamide composition of any one of Aspects 90-91, wherein the reinforcing fiber is 25 wt % to 50 wt % of the fiber-compounded polyamide composition.

Aspect 93 provides the fiber-compounded polyamide composition of any one of Aspects 90-92, wherein the reinforcing fiber comprises carbon fibers, carbon nano-fibers, glass fibers, basalt fibers, natural fibers, mineral fibers, nano-cellulosic fibers, wood fibers, non-wood plant fibers, or a combination thereof.

Aspect 94 provides the fiber-compounded polyamide composition of any one of Aspects 90-93, wherein the reinforcing fiber comprises glass fibers.

Aspect 95 provides the fiber-compounded polyamide composition of any one of Aspects 90-94, wherein at least 25% of the reinforcing fiber has a length ≥0.5 mm, as determined via number-averaged fiber length.

Aspect 96 provides the fiber-compounded polyamide composition of any one of Aspects 90-95, wherein 25-68% of the reinforcing fiber has a length ≥0.5 mm, as determined via number-averaged fiber length.

Aspect 97 provides the fiber-compounded polyamide composition of any one of Aspects 90-96, wherein the reinforcing fiber is glass fibers, wherein at least 25% of the reinforcing fiber has a length ≥0.5 mm, as determined via number-averaged fiber length.

Aspect 98 provides the fiber-compounded polyamide composition of any one of Aspects 90-97, wherein the fiber-compounded polyamide composition is an extruded sheet, an extruded pellet, a compression molded article, or an injection molded article.

Aspect 99 provides a fiber-compounded polyamide composition comprising:
a compounded polyamide composition that is 40 wt % to 90 wt % of the fiber-compounded polyamide composition, the compounded polyamide composition comprising
   PA66 that is 25 wt % to 85 wt % of the compounded polyamide composition, and
   a polymer additive that is 5 wt % to 70 wt % of the compounded polyamide composition, the polymer additive comprising
      PA66/DI,
      PA66/D6
      PA6I/6T,
      PA6, or
      a combination thereof, and
glass fibers that are 10 wt % to 60% of the fiber-compounded polyamide composition, wherein at least 25% of the glass fibers have a length ≥0.5 mm as determined via number-averaged fiber length.

Aspect 100 provides a method of forming the compounded polyamide composition of any one of Aspects 36-99, the method comprising:
feeding a composition comprising PA66 and a polymer additive to a compounding zone, the polymer additive comprising
   a polyamide copolymer,
   a polymer comprising a repeating unit comprising a styrene reaction product,
   a polyamide formable via ring-opening polymerization,
   a polyamide comprising a repeating unit comprising a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6, or
   a combination thereof;
maintaining conditions in the compounding zone to blend the composition to form a melted compounded polyamide composition; and
producing extrudate from the melted compounded polyamide composition to form the polyamide composition.

Aspect 101 provides a molded article formed from the compounded polyamide composition of any one of Aspects 36-99.

Aspect 102 provides the molded article of Aspect 101, wherein the molded article is free of reinforcing fibers.

Aspect 103 provides the molded article of Aspect 101, wherein the molded article comprises reinforcing fibers.

Aspect 104 provides the molded article of any one of Aspects 101-103, wherein the molded article has a tensile strength in a length-wise direction of 150 MPa to 300 MPa as measured on a sample having less than 0.2 wt % water.

Aspect 105 provides the molded article of any one of Aspects 101-104, wherein the molded article has a tensile strength in a length-wise direction of 165 MPa to 270 MPa as measured on a sample having less than 0.2 wt % water.

Aspect 106 provides the molded article of any one of Aspects 101-105, wherein the molded article has an elongation at break in a length-wise direction of 1% to 10% as measured on a sample having less than 0.2 wt % water.

Aspect 107 provides the molded article of any one of Aspects 101-106, wherein the molded article has an elongation at break in a length-wise direction of 2.5% to 4.5% as measured on a sample having less than 0.2 wt % water.

Aspect 108 provides the molded article of any one of Aspects 101-107, wherein the molded article has a tensile modulus in a length-wise direction of 5,000 MPs to 25,000 MPa as measured on a sample having less than 0.2 wt % water.

Aspect 109 provides the molded article of any one of Aspects 101-108, wherein the molded article has a tensile modulus in a length-wise direction of 6,500 MPa to 18,000 MPa as measured on a sample having less than 0.2 wt % water.

Aspect 110 provides the molded article of any one of Aspects 101-109, wherein the molded article has a 23° C. unnotched Charpy impact strength in a length-wise direction of 35 kJ/m² to 100 kJ/m² as measured on a sample having less than 0.2 wt % water.

Aspect 111 provides the molded article of any one of Aspects 101-110, wherein the molded article has a 23° C. unnotched Charpy impact strength in a length-wise direction of 45 kJ/m² to 80 kJ/m² as measured on a sample having less than 0.2 wt % water.

Aspect 112 provides the molded article of any one of Aspects 101-111, wherein the molded article has a 23° C. notched Charpy impact strength in a length-wise direction of 15 kJ/m² to 35 kJ/m² as measured on a sample having less than 0.2 wt % water.

Aspect 113 provides the molded article of any one of Aspects 101-112, wherein the molded article has a 23° C. notched Charpy impact strength in a length-wise direction of 17 kJ/m² to 27 kJ/m² as measured on a sample having less than 0.2 wt % water.

Aspect 114 provides the molded article of any one of Aspects 101-113, wherein the molded article has a tensile strength in a cross-wise direction of 35 MPa to 120 MPa as measured on a sample having less than 0.2 wt % water.

Aspect 115 provides the molded article of any one of Aspects 101-114, wherein the molded article has a tensile strength in a cross-wise direction of 45 MPa to 100 MPa as measured on a sample having less than 0.2 wt % water.

Aspect 116 provides the molded article of any one of Aspects 101-115, wherein the molded article has an elongation at break in a cross-wise direction of 0.5% to 3.5% as measured on a sample having less than 0.2 wt % water.

Aspect 117 provides the molded article of any one of Aspects 101-116, wherein the molded article has an elongation at break in a cross-wise direction of 1% to 2.8% as measured on a sample having less than 0.2 wt % water.

Aspect 118 provides the molded article of any one of Aspects 101-117, wherein the molded article has a tensile modulus in a cross-wise direction of 3,000 MPa to 10,000 MPa as measured on a sample having less than 0.2 wt % water.

Aspect 119 provides the molded article of any one of Aspects 101-118, wherein the molded article has a tensile modulus in a cross-wise direction of 4,000 MPa to 8,000 MPa as measured on a sample having less than 0.2 wt % water.

Aspect 120 provides the molded article of any one of Aspects 101-119, wherein the molded article has a 23° C. unnotched Charpy impact strength in a cross-wise direction of 8 kJ/m² to 30 kJ/m² as measured on a sample having less than 0.2 wt % water.

Aspect 121 provides the molded article of any one of Aspects 101-120, wherein the molded article has a 23° C. unnotched Charpy impact strength in a cross-wise direction of 10 kJ/m² to 22 kJ/m² as measured on a sample having less than 0.2 wt % water.

Aspect 122 provides the molded article of any one of Aspects 101-121, wherein the molded article has a 23° C. notched Charpy impact strength in a cross-wise direction of 4 kJ/m² to 20 kJ/m² as measured on a sample having less than 0.2 wt % water.

Aspect 123 provides the molded article of any one of Aspects 101-122, wherein the molded article has a 23° C. notched Charpy impact strength in a cross-wise direction of 6 kJ/m² to 11 kJ/m² as measured on a sample having less than 0.2 wt % water.

Aspect 124 provides the molded article of any one of Aspects 101-123, wherein the molded article is an automotive part.

Aspect 125 provides the molded article of any one of Aspects 101-124, wherein the molded article is an automotive part comprising an automotive structural component, a battery case, a battery tray, a dashboard carrier, a front-end, a bumper, a bumper carrier, an underfloor component, an oil pan, a spare wheel recess, an underbody component, an underbody shield, or a combination thereof.

Aspect 126 provides the molded article of any one of Aspects 101-125, wherein the molded article is a molded article formed from the fiber-compounded polyamide composition of any one of Aspects 90-99.

Aspect 127 provides a molded article formed from the fiber-compounded polyamide composition of any one of Aspects 90-99.

Aspect 128 provides a method of forming a molded article, the method comprising:
placing the compounded polyamide composition of any one of Aspects 36-99 into a mold to form the molded article; and
removing the molded article from the mold.

Aspect 129 provides the method of Aspect 128, comprising placing an extruded sheet of the compounded polyamide composition of any one of Aspects 36-99 into the mold.

Aspect 130 provides the method of Aspect 128, wherein the method comprises placing the fiber-compounded polyamide composition of any one of Aspects 90-99 into a mold to form the molded article.

Aspect 131 provides the method of any one of Aspects 128-130, comprising:
melting the compounded polyamide composition of any one of Aspects 36-89 and combining the melt with reinforcing fibers to form the fiber-compounded polyamide composition of any one of Aspects 90-99; and
placing the fiber-compounded polyamide composition into the mold.

Aspect 132 provides the method of any one of Aspects 128-131, wherein the method is a compression molding process.

Aspect 133 provides the method of any one of Aspects 128-132, further comprising compressing the fiber-compounded polyamide composition in the mold.

Aspect 134 provides the method of Aspect 100, wherein the method is a method of direct long fiber thermoplastic molding (D-LFT) or long fiber thermoplastic direct molding (LFT-D).

Aspect 135 provides a molded article formed by the method of Aspect 100.

Aspect 136 provides a method of forming a fiber-reinforced molded article, the method comprising:
placing the fiber-compounded polyamide composition of any one of Aspects 90-99 into a mold to form the fiber-reinforced molded article; and
removing the fiber-reinforced molded article from the mold.

Aspect 137 provides a fiber-reinforced molded article formed by the method of Aspect 136.

Aspect 138 provides a method of improving direct long fiber thermoplastic molding (D-LFT) or long fiber thermoplastic direct molding (LFT-D) of a fiber-compounded polyamide composition, the method comprising:
including a sufficient amount of polymer additive in the fiber-compounded polyamide composition such that a lower melt flow index, melt temperature, crystallization temperature, or combination thereof, is achieved, wherein the fiber-compounded polyamide composition comprising the polymer additive comprises a compounded polyamide composition comprising
   PA66 that is ≥20 to ≤99 wt % of the compounded polyamide composition,
   a polymer additive that is ≥1 to ≤70 wt % of the compounded polyamide composition, and
   reinforcing fibers that are 10 wt % to 60% of the fiber-compounded polyamide composition;
wherein the polymer additive comprises
   a polyamide copolymer,
   a polymer comprising a repeating unit comprising a styrene reaction product,
   a polyamide formable via ring-opening polymerization,
   a polyamide comprising a repeating unit comprising a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6, or
   a combination thereof.

Aspect 139 provides the composition of any one of Aspects 1-7, 15-22, 25-27, or 30-99, further characterized by the peak crystallization slow-down factor, F_{slowdown}, from one selected from:
≥1.8 to ≤3.1;
3 to 11; and
1 to 15.

Aspect 140 provides the method of any one of Aspects 8, 100, or 128-138 wherein the polymer composition used in the method is further characterized by the peak crystallization slow-down factor, F_{slowdown}, from one selected from:
≥1.8 to ≤3.1;
3 to 11; and
1 to 15.

Aspect 141 provides an apparatus or article of any one of Aspects 9-14, 23-24, 28-29, 101-127, or 135-137, wherein the apparatus comprises a polymer composition characterized by the peak crystallization slow-down factor, F_{slowdown}, from one selected from:
≥1.8 to ≤3.1;
3 to 11; and
1 to 15.

Aspect 142 provides the composition, method, or article of any one or any combination of Aspects 1-141 optionally configured such that all elements or options recited are available to use or select from.

What is claimed is:

1. A compounded thermoplastic resin comprising:
from ≥20 to ≤99 wt. %, based on the total mass of the compounded thermoplastic resin, of a polyamide composition comprising a polyamide having a relative viscosity (RV) of from ≥20 to ≤50 measured at room temperature and pressure (RV determined from a 8.4 wt % polyamide solution in 90% formic acid and RV is the ratio of the viscosity of the solution to the viscosity of the solvent);
up to ≤70 wt. %, based on the total mass of the compounded thermoplastic resin, of a random copolymer composition; and
up to 50 wt. %, based on the total mass of the compounded thermoplastic resin, of a co-polyamide of hexamethylene isophthalamide and hexamethylene terephthalamide (PA6I/6T);
wherein, the compounded thermoplastic resin is characterized by Melt Flow Index (MFI) of 10 to 80 g/10 min., melt temperature range of 245-265° C., and crystallization temperature range of 195-220° C.; and wherein the MFI is measured according to ISO Method 1133 for 0.325 kg sample weight having between 0.13 wt. % to 0.20 wt. % moisture at 275° C. test temperature.

2. The compounded thermoplastic resin of claim 1, wherein the polyamide composition has an amine end group (AEG) value in the range of ≥30 to ≤130 milliequivalents/kg (meq/kg).

3. The compounded thermoplastic resin of claim 1, wherein the polyamide composition has an amine end group (AEG) value in the range of 30 meq/kg to ≤70 meq/kg.

4. The compounded thermoplastic resin of claim 1, wherein the polyamide composition has an amine end group (AEG) value in the range of 65 meq/kg to 130 meq/kg.

5. The compounded thermoplastic resin of claim 1, wherein the polyamide in the polyamide composition is polyhexamethylene adipamide (PA66).

6. The compounded thermoplastic resin of claim 1, wherein the random copolymer composition comprises at least one selected from:
a copolymer of polyhexamethylene adipamide (PA66) and poly-2-methylpentamethylene isophthalamide (DI), wherein the mass ratio of copolymer (PA66/DI) is from 80:20 to 97:3;
a copolymer of polyhexamethylene adipamide (PA66) and poly-2-methylpentamethylene adipamide (D6), wherein the mass ratio of copolymer (PA66/D6) is from 70:30 to 90:10;
a copolymer of polyhexamethylene adipamide (PA66) and polyhexamethylene terephthalamide (6T), wherein the mass ratio of copolymer (PA66:6T) is from 75:25 to 55:45;
a copolymer of poly-2-methylpentamethylene terephthalamide (DT) and poly-2-methylpentamethylene isophthalamide (DI), wherein the mass ratio of copolymer (DT/DI) is from 60:40 to 40:60;
syndiotactic polystyrene (SPS);
styrene-maleic anhydride (SMA); and
imidized styrene-maleic anhydride (SMI).

7. The compounded thermoplastic resin of claim 1, further comprising up to 60 wt. %, based on the total mass of the compounded thermoplastic resin, of a non-polyhexamethylene adipamide (non-PA66) component.

8. The compounded thermoplastic resin of claim 7, wherein the non-polyhexamethylene adipamide (non-PA66) component comprises at least one selected from polycaproamide (PA6), polyheptanamide (PA7), polynonanamide (PA9), polyhexamethylene decanamide (PA610), polyhexamethylene dodecanamide (PA612), polytetramethylene adipamide (PA46), polytetramethylene sebacamide (PA410), polypentamethylene adipamide (PA56), polyhexamethylene azelamide (PA69), polypentamethylene sebacamide (PA510), polydecamethylene sebacamide (PA1010), polydecamethylene dodecanamide (PA1012), polypentamethylene dodecanamide (PA512), polydodecamethylene dodecanamide (PA1212), polyundecanamide (PA 11), polylaurolactam (PA12) and copolymer of poly-hexamethylene terephthalamide and poly-2-methylpentamethylene terephthalamide (PA6T/DT).

9. The compounded thermoplastic resin of claim 1, further comprising ≥0.1 to ≤2 wt. % heat stabilizer based on the total mass of the resin.

10. The compounded thermoplastic resin of claim 1 where the polyamide composition comprises any of the copolymers i) to iii) of claim 4.

11. The composition of claim 1, wherein the compounded thermoplastic resin is characterized by a peak crystallization slow-down factor, F_{slowdown}, from one selected from:
≥1.8 to ≤3.1;
3 to 11; and
1 to 15.

12. A molding composition comprising:
a first component comprising PA66 polyamide having RV from ≥20 to ≤50 measured at room temperature and pressure (RV determined from a 8.4 wt % polyamide solution in 90% formic acid and RV is the ratio of the viscosity of the polyamide solution to the viscosity of the solvent);
a second component comprising glass fibers where the cumulative number-averaged distribution of the glass fiber in the 0.5-5 mm linear length is ≥20% to ≤70% by weight, based upon total weight of glass fibers in the molding composition; and
a third component selected from at least partially aromatic polyamides and at least partially branched aliphatic polyamides, the third component present in the molding composition at concentration sufficient to suppress molding fractures when a Direct Long Fiber Thermoplastic (DLFT) molding preform is pressed into a DLFT mold at temperature of from 240° C. to 265° C.

13. A compounded polyamide composition comprising:
PA66 or PA66/D6 or PA66/DI that is ≥20 to ≤99 wt % of the compounded polyamide composition; and
a polymer additive that is up to ≤70 wt % of the compounded polyamide composition, the polymer additive comprising
a polyamide copolymer,
a polymer comprising a repeating unit comprising a styrene reaction product,
a polyamide formable via ring-opening polymerization,
a polyamide comprising a repeating unit comprising a reaction product of H₂N—(CH₂)ₓ—NH₂ and HOC(O)—(CH₂)_{y}—C(O)OH, wherein x is an integer that is ≥6 and ≤12, y is an integer that is ≥4 and ≤10, and x and y are not both 6, or
a combination thereof.

14. The compounded polyamide composition of claim 13, wherein the PA66/DI is 30 wt % to 70 wt % of the compounded polyamide composition.

15. The compounded polyamide composition of claim 13, wherein the PA66/DI is 50 wt % to 70 wt % of the compounded polyamide composition.

16. The compounded polyamide composition of claim 13, wherein the PA66/DI is 80 wt % to 99 wt % PA66 and 1 wt % to 20 wt % DI.

17. The compounded polyamide composition of claim 13, wherein the compounded thermoplastic resin is further characterized by a peak crystallization slow-down factor, F_{slowdown}, from one selected from:
≥1.8 to ≤3.1;
≥3 to ≤11; and
≥1 to ≥15.

18. A fiber-compounded polyamide composition comprising:
the compounded polyamide composition of claim 13; and
a reinforcing fiber.

19. The fiber-compounded polyamide composition of claim 18, wherein the reinforcing fiber is 10 wt % to 60 wt % of the fiber-compounded polyamide composition, wherein the reinforcing fiber comprises glass fibers.

20. A method of making the compounded thermoplastic resin of claim 1, the method comprising:
feeding to a compounding zone a polyamide, a random copolymer, a co-polyamide of hexamethylene isophthalamide and hexamethylene terephthalamide, and a heat stabilizer.
maintaining conditions in the compounding zone to blend the contents to form a homogeneous compounded thermoplastic resin melt;
recovering the homogeneous compounded thermoplastic resin melt; and
producing extrudate from the recovered homogeneous compounded thermoplastic resin melt.
